(19) United States
(12) Patent Application Publication
(10) Pub. No.: US 2007/0203778 A1
(43) Pub. Date: Aug. 30, 2007

(54) WORKFLOW MANAGEMENT

(75) Inventors: John Lowson, Thornill, ON (CA); Kristin M. Patey, Milwaukee, WI (US)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: ACCENTURE GLOBAL SERVICES GMBH, CH-8200 Shaffhausen (CH)

(21) Appl. No.: 11/276,414

(22) Filed: Feb. 28, 2006

(51) Int. Cl. G06F 9/46

(52) U.S. Cl. 705/9

(57) ABSTRACT

Methods and system for managing workflow in an information data processing system are described herein. A workflow server communicates with and receives work items from one or more information systems, such as a customer information system. Work items may include exceptions spawned by each information system, e.g., an item or error requiring manual resolution. The workflow server assigns each work item to an employee queue based on a comparison of skills needed to resolve the work item with skills of each end-user available to resolve a work item. The workflow server tracks work item assignments and resolutions by various indicators, such as by employee, business sector, and the like, and maintains an audit trail for later analysis and reporting of workflow resolutions.

### FIELD OF THE INVENTION

The invention relates generally to automated systems for workflow management. More specifically, the invention provides methods and systems for managing and tracking exceptions and exception handlers in a customer information system.

### BACKGROUND OF THE INVENTION

A Customer Information System (CIS) broadly refers to a software application or suite of software applications used to track customer information by a provider of goods and/or services. For example, utility companies use a customer information system to track their customers' data, e.g., names, addresses, power consumption, account status, etc. A CIS application may be responsible for automating one or more aspects of a company's business processes, e.g., generation of bills, processing meter readings, etc. When a CIS does not successfully perform a desired operation, an exception occurs. Company personnel must then manually resolve each exception to restore normal operations with respect to the issue which caused the exception in the first place.

Customer information systems have now progressed through multiple generations of development. As a result, a company may use multiple and/or different CIS applications or even multiple generations (or legacy systems) of the same CIS. Company personnel must therefore resolve exceptions in multiple systems, each having different procedures and requirements. FIG. 1 illustrates a prior art architecture 101 of a company using multiple CIS applications. As is shown in FIG. 1, a company using six different CIS applications must train and dedicate staff to each CIS, and use different reporting tools for each CIS. This is inefficient and makes tracking and managing exceptions more difficult.

Thus, it would be an advance in the art to provide a workflow management system that coordinates exceptions from multiple CIS applications, thereby allowing company personnel to manage and handle exceptions on a more efficient basis.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

To overcome limitations in the prior art described above, and to overcome other limitations that will be apparent upon reading and understanding the present specification, aspects of the present invention are directed to methods and systems for managing workflow. A first aspect of the invention provides a system including a customer information system (CIS) generating work items corresponding to a business entity operating the CIS, a work item database, and a workflow management module communicatively connected to the CIS. The workflow management module receives the work items from the CIS, and stores information corresponding to the work items in the work item database. The workflow management module automatically assigns each work item to an employee work queue selected from a group of employee work queues based on a skill set associated with each work item and a skill set associated with each employee work queue. The workflow management module stores audit trail data corresponding to each work item in the work item database.

A second aspect of the invention provides a method of managing an exception in an information system, by receiving a first exception from a first application of the information system, where the first exception corresponds to a request for manual resolution, identifying a first end-user to resolve the first exception, assigning the first exception to the first end-user, receiving a second exception from a second application of the information system, where the second exception corresponds to a request for manual resolution, and where the second application is different from the first application, determining a second end-user to resolve the second exception, and assigning the second exception to the second end-user.

Another aspect of the invention provides an information system for processing exceptions. The information system may include multiple service applications, where each of the service applications is configured to automatically resolve tasks and generate one or more exceptions corresponding to tasks that require manual resolution. The information system may further include a data server for receiving the exceptions from the service applications, where the data server configures data associated with each of the one or more exceptions to conform to a predefined format. The information system may also include a workflow manager configured to assign each exception to an end-user based on a comparison of skills associated with the exception and skills of the end-user.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a prior art workflow block diagram.

FIG. 2 illustrates a software architecture and workflow according to one or more illustrative aspects described herein.

FIG. 3 illustrates a flowchart for a method of routing and resolving work items according to one or more illustrative aspects described herein.

FIG. 4 illustrates a block diagram of a software architecture according to one or more illustrative aspects described herein.

FIGS. 5-31 each illustrate a screenshot of a user view in a Workflow Management Application according to one or more illustrative aspects described herein.

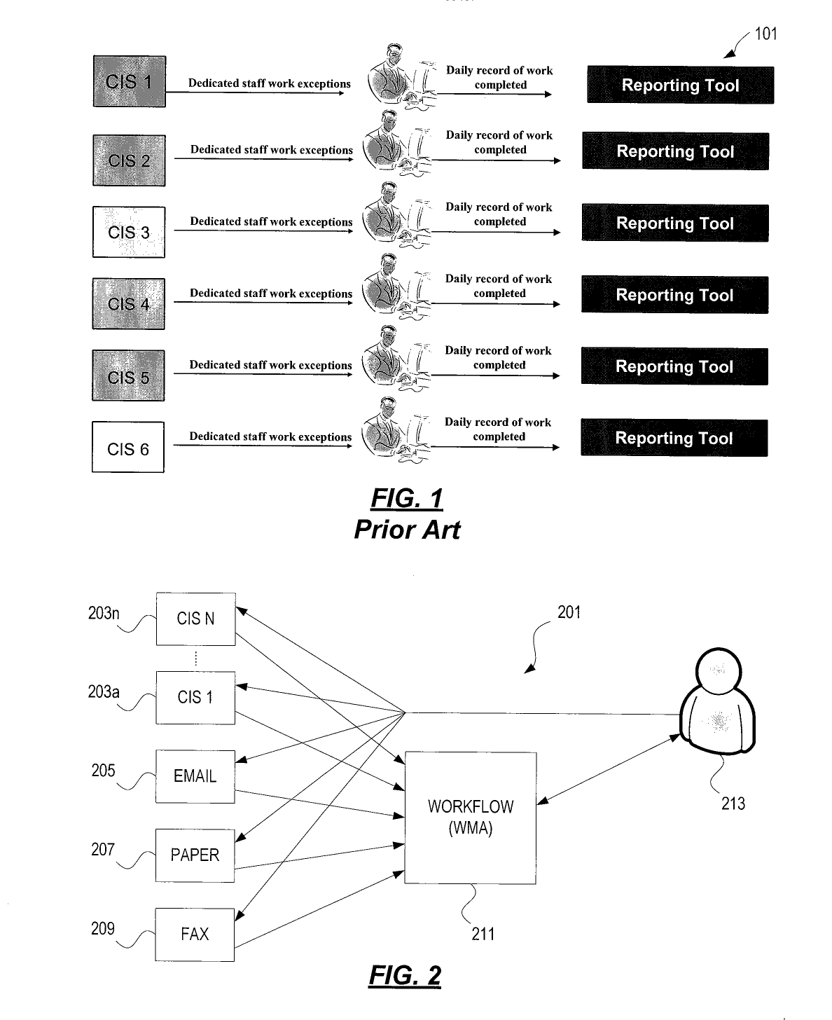

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

By way of general introduction, one or more companies, entities, and/or users may use one or more aspects of the invention to manage and streamline performance of management processes by employees handling exceptions created by a customer information system (CIS), including productivity, scheduling, and quality control. Aspects described herein are usable to enable automated and efficient tracking and reporting of work performed by company employees in handling exceptions, automatic assignment and re-assignment of work based on knowledge of staff availability and capabilities, and facilitation of the distribution of work to multiple locations while retaining centralized scheduling and management, if desired.

Aspects described herein are particularly useful for companies providing goods and/or services where work items such as exceptions occur, which can be handled in a relatively short amount of time (e.g., within a day, or under 2 hours). For example, a utility company may use a CIS application to manage customer data and accounts. An exception may occur when the CIS cannot automatically print a customer's monthly bill for mailing, due to any of a variety of circumstances. For example, the exception may occur because the utility company failed to get an automatic reading of the customer's usage (e.g., power consumption), and/or because the customer's address is missing a zip code. An employee of the utility company must then determine why the bill did not print, manually resolve the exception, and mark the exception as resolved in the CIS so that the CIS can print and mail the appropriate bill to the customer. This is but one illustrative example of an exception, and is not intended to be limiting to any extent.

Throughout this description, exceptions are used an example of a work item that can be managed using the systems and methods described herein. The use of exceptions is for illustrative purposes only, and is not intended to be limiting in any respect. The methods and systems described herein are useful not only with exception management, but also with the management of any type of work item for which a pool of employees may be responsible for handling that type of work item. Other examples may include work “tickets” or items in a helpdesk environment, and the like.

FIG. 2 illustrates an illustrative architecture 201 and workflow according to aspects described herein. A workflow management application (WMA) 211 may coordinate communication between one or more CIS applications 203a-203n and a user 213. WMA 211 may also coordinate incoming email 205, scanned paper 207, fax communications 209, and other incoming communications (not shown). User 213 interacts with WMA 211 to obtain work assignments and mark work as complete, e.g., when the handling of an exception has been completed, and may also interact with WMA 211 to input data regarding an unresolved exception (e.g., to reassign the exception to another employee capable of resolving the exception). User 213 might interact directly with CIS 203a-203n when handling exceptions, e.g., the user might need to interface directly with a CIS application in order to identify the cause of an exception, or to input data to resolve the exception.

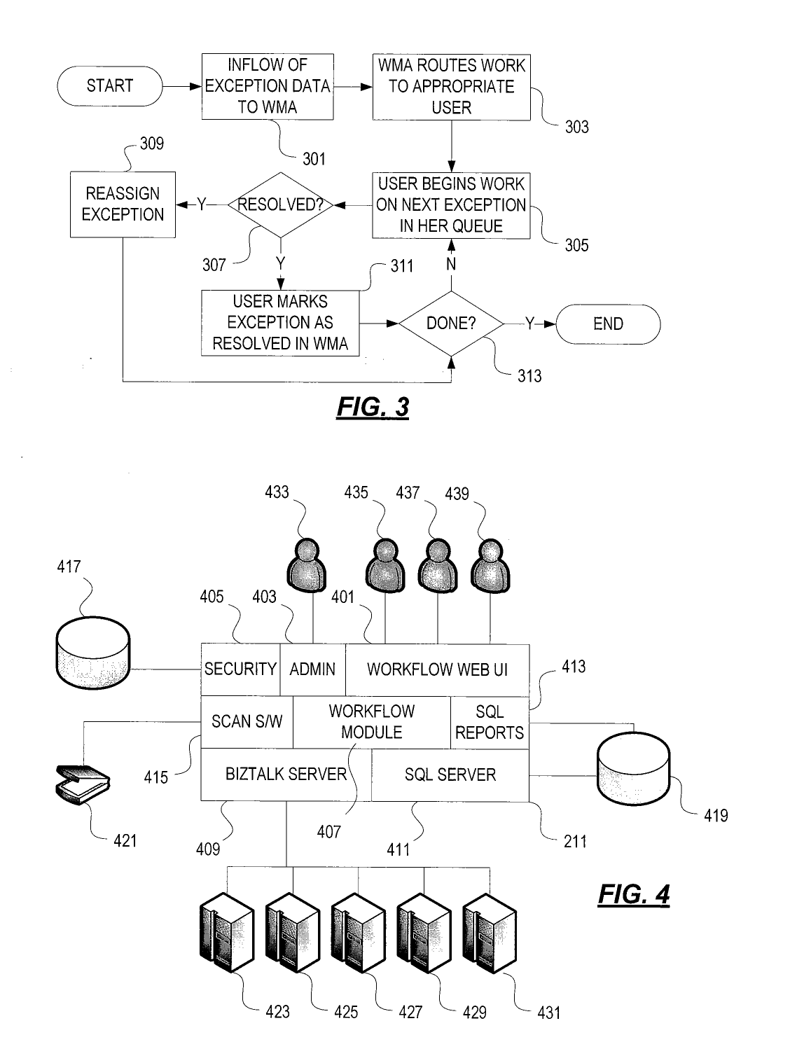

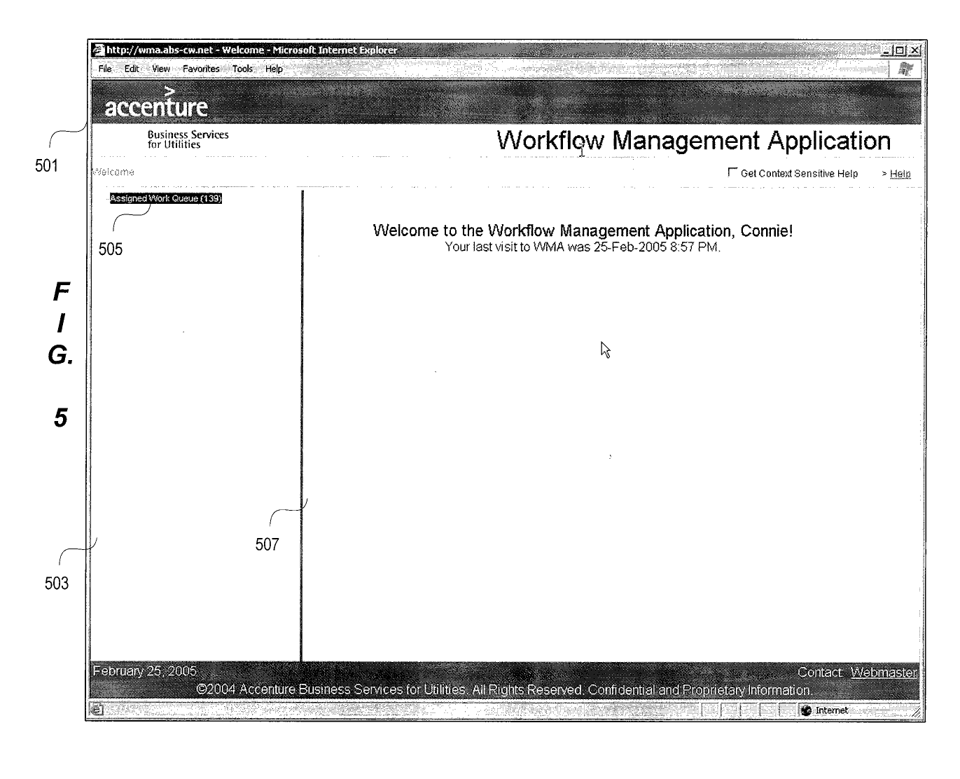

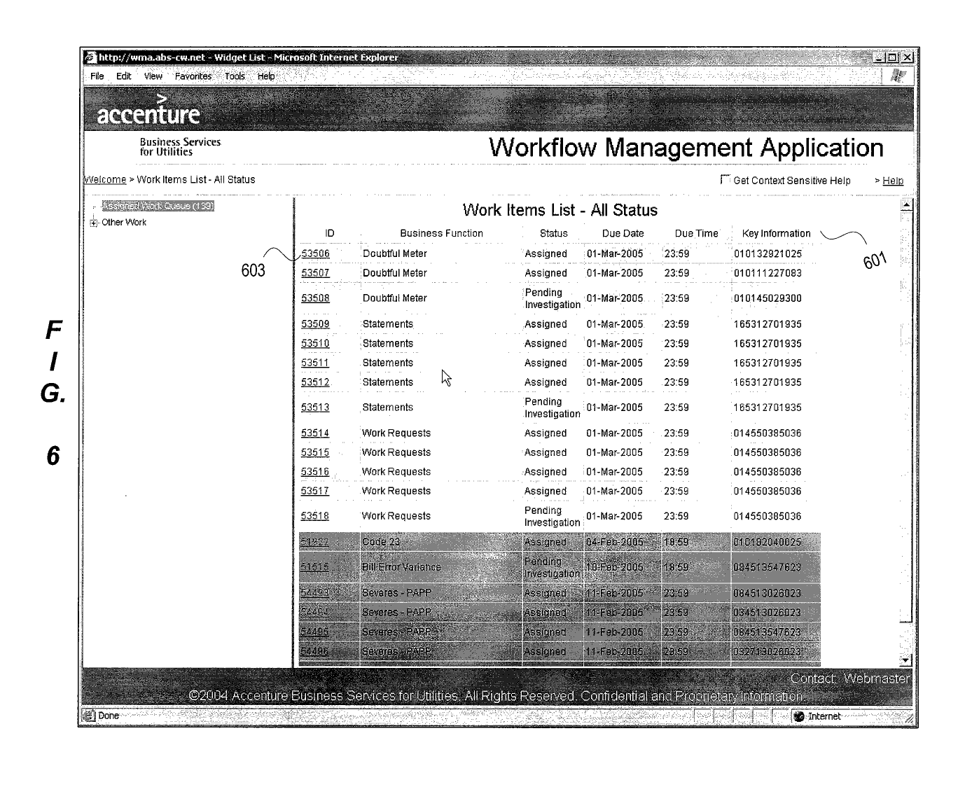

FIG. 3 illustrates a flowchart of a method of handling and managing exceptions according to an illustrative aspect of the invention. In step 301, exceptions are routed to WMA 211 as they arrive at the host company. For example, as indicated above, an exception might arrive via an automated process that does not complete as expected in a CIS application. Each CIS application or other computer executed application might be connected to WMA 211, e.g., via an API or other interface. Exceptions might also arise as a result of a customer telephone call (e.g., indicating a problem), which is then manually entered into WMA 211 by a user, or which is automatically recorded and/or entered into WMA 211, e.g., based on user input via a touch tone or voice responsive telephone input system. Exceptions can also be input into WMA 211 based on received communications, such as emails, facsimiles, voice mails, etc. According to an illustrative aspect, the received communication may be recorded and/or stored in WMA 211, tagged as an unknown exception, and initially set to be handled by an exception sorter (e.g., an entry level employee who parses unknown exceptions, determines what type of exception the unknown exception really is, and assigns the exception to an appropriate employee for further handling). Exceptions may also be manually entered into WMA 211 by a user of WMA 211, e.g., using a specially designated exception input screen. Because exceptions may be received from any variety of sources, there might be no standard incoming format for exception data structures. According to one aspect, message-based application integration Server 409 (FIG. 4, discussed below) may convert incoming exceptions into a data structure in use by WMA 211. That is, server 409 may be configured to communicate with systems that are not natively compatible with WMA 211, to transform data into a format usable by WMA 211.

In step 303, WMA 211 routes exceptions to the appropriate employee's work queue(s). In one example, the company using WMA 211 may employ multiple employees whose job entails handling exceptions. Such employees may include operators, customer service representatives, or the like, and such employees are generally entry-level employees with limited skill sets. Some employees may have more or fewer skills than others, e.g., based on special training, length of time at the company, supervisory or management roles, etc. The company may provide banks of generic workstations at which each employee can perform his/her job duties, without the need to maintain employee-specific workstations. That is, each employee, upon arrival, can perform his or her duties from any of the generic workstations, without being assigned to the same workstation each time he or she is at work.

Thus, in step 303, WMA 211 assigns the handling of each exception to an employee with the requisite skill set, and also based on employee availability (e.g., the employee is presently at work, and is available to handle an exception). Thus, if an exception occurs identifying a missing zip code in a customer address, virtually any employee could handle obtaining the zip code and entering the zip code in the proper CIS system. However, if an exception occurs indicating that a customer has requested a refund for some stated reason, the exception might need to be routed to a manager or other personnel with authority to provide refunds to customers. In addition, where multiple employees could handle a given exception, WMA 211 might assign the exception to an employee with the shortest work queue. Alternatively, WMA 211 might maintain different exception queues based on types of exceptions. When an employee is available to take another exception to attempt to resolve the exception, WMA 211 might simply assign that employee the next exception from any exception queue matching the employee's skill set. According to one aspect, an exception might be routed based on who handled a previous, related exception, e.g., an exception might be routed to the same employee who handled a previous exception based on the same customer.

In step 305, the assigned employee attempts to resolve the exception through the established procedures of the company. In steps 307 and 309, if the employee does not resolve the exception, the exception is reassigned. An employee might not be able to resolve an exception, for example, if the employee's shift ends prior to resolving the exception, or if the employee, in the course of attempting to resolve the exception, determines that the employee does not have the appropriate information, skill set or authority to the resolve the exception. An exception may be assigned to another employee, e.g., where the previous employee did not have authority or the skill set to resolve the exception. Alternatively, if the employee does not presently have enough information to resolve the exception, the exception may be reassigned to a holding queue, or otherwise be temporarily put on hold, until the necessary information is obtained (at which point the exception may be reassigned to the same or a different employee). If in steps 305 and 307 the employee does resolve the exception, then in step 311 the employee marks the exception as resolved in WMA 211. Alternatively, when the employee requests another exception for handling from WMA 211, WMA 211 might automatically mark the previous exception as resolved.

In step 313 WMA 211 determines whether the user/employee is done handling exceptions, e.g., because there are no more exceptions remaining, or because the user's work schedule is nearing completion or is over for the day. If the employee is not done, WMA 211 returns to step 305 to attempt to resolve the next exception in the appropriate queue. Alternatively (not shown), WMA 211 may return to step 303 to assign another exception to the employee, if the employee's work queue is empty.

FIG. 4 illustrates a more detailed block diagram of WMA 211 and its connected systems, databases, and users. WMA 211 may include various components, and FIG. 4 is merely one illustrative embodiment. In the illustrated embodiment, WMA 211 may include a user interface module 401, e.g., providing a web interface through which users 435, 437, and 439 (e.g., department managers, team leads and managers, and end-users) receive workflow (e.g., exceptions), through which users mark exceptions complete, and through which users otherwise interact with WMA 211. WMA 211 may further include an administrative module 433 through which administrators 433 manage various controls and settings of WMA 211, further discussed below, and a security module 405 that communicates with security database 417, e.g., an Active Directory database. WMA 211 may also include a scanning module 415 for receiving scanned documents from scanner 421, a workflow module 407 which acts as the central “brain” of WMA 211, a message-based application integration server module 409 (e.g., a BizTalk server 2004) for communicating with external systems 423, 425, 427, 429, and 431, and an SQL server 411 and SQL reporting module 413 that also communicate with database 419, e.g., an OLAP DataWarehouse. External systems 423, 425, 427, 429, and 431 may include a fax server 423, Microsoft exchange or other email server 425, legacy CIS server 427, other legacy CIS server 429, and third party packaged CIS application 431 (e.g., an Energy CIS system in the utility example above). Other and/or different systems which provide or create exceptions may also or alternatively be included.

Message-based application integration server module 409, SQL server 411, and SQL reporting module 413 may be obtained from a vendor such as Microsoft Corporation of Redmond, Wash. Scanning module 415 may also be obtained from any variety of third-party scanning software vendors. The components of FIG. 4 are communicatively connected, meaning that each component is either directly or indirectly connected to all other components such that data can be electronically transmitted from any component to any other component. The modules illustrated in FIG. 4 may be implemented in hardware or software, and represent logical components. That is, each module may reside in different physical computers or simply be logically separate within a common computer or server. The modules in FIG. 4 are representative, and may be combined or further split up based on the desired network architecture.

As indicated above, workflow module 407 includes the principal logic and algorithms responsible for receiving and categorizing exceptions from external systems 423-431, assignment of work (e.g., exceptions for resolution) to end users 435-439, and receiving input from end-users 435-439. For example, workflow module 407 may include the software logic executable to perform the methods described herein, and including at least the method of FIG. 3. In addition, workflow module 407 may include control logic (e.g., software) to integrate WMA 211 with legacy systems in real time, e.g., using the message-based application integration server 409. Workflow module 407 may also integrate with third party exception files, e.g., files for payment processing, collection agencies, etc. Workflow module 407 also includes the control logic to interface with paper systems, e.g., via scanning module 415. Paper systems can include any received paper document indicative of an exception, e.g., including customer complaints, work orders from vendors, transformer billing forms from other companies, etc. Workflow module 407 also manages inbound email received from a connected exchange server, e.g., system 423.

Workflow module 407 prioritizes exceptions for handling by employees. Prioritization may be based on a critical nature of an exception versus a non-critical nature of an exception. Prioritization may be based on how old the exception is, or when the exception was created or identified. Prioritization may further be based on any combination of factors, including priority, critical nature, age, dollar value, expected time to resolution, manpower required for resolution, or other identified characteristics. Prioritization may also be based on bill cycle, date received and turnaround time, by hour (within 48 or 72 business hours), or needed date (set date), account status, or amount (for example, amount owed by the customer or vendor).

Workflow module 407 may provide managers and/or administrators the ability to sort work in a queue to show the prioritization of the exceptions. That is, the manager may have the ability to sort and filter (for example, greater than or less than, color coding, etc.) exceptions to re-prioritize the exceptions, or to simply view the existing prioritization of the work/exceptions.

As indicated above, workflow module 407 automatically routes work based on skill set of each employee available to handle exceptions. Workflow module 407 may assign each type of exception a skill set, and each end user may also have a corresponding skill set. Workflow module 407 assigns work to an end-user/employee if the work type skill set matches the end user skill set, or if the end-user skill set at least includes the skill set identified for the type of exception. This requirement assumes the ‘push’ work model for managing work, where exceptions are pre-assigned to employees, rather than employees ‘pulling’ an exception when they have availability. Workflow module 407 may automatically route work based on the availability of end-user employees. For end users who are part of teams dedicated to handling the work from the workflow module, the workflow module 407 accesses their schedule to be able to ‘push’ work to those end users when they are at work. The schedule may include the number of minutes scheduled in each day, sick days, vacation days, flex days, unexpected leaves in the middle of the day, etc., and route work appropriately. The workflow module 407 may place a cap on the number of unresolved exceptions an employee may have in his or her queue at any given time.

Workflow module 407 may alternatively manually route work based on user input from a manager or other supervisory employee. Thus, work can be assigned to any employee as desired on a case-by-case basis, if needed. Also, as indicated above, a user may ‘pull’ work from a work queue. That is, workflow module 407 provides the ability for a user to pull work when that user might otherwise be idle. For example, correspondence may be performed by Customer Service Representatives (CSRs) in a call center during idle time between calls. This work therefore cannot be ‘pushed’ to the CSRs, but instead, there may be a prioritized queue of work that the CSRs can “pull” from during idle time. The system may allow employees to pull work at other times, and workflow module 407 may filter exceptions visible to an employee for pulling based on skill set. That is, each employee might only see and/or might only be able to pull exceptions that can be handled by that employee.

Workflow module 407 may also provide for the display of urgency levels for each exception or other work item. An example would be that when a piece of work is in danger of being overdue, workflow module 407 makes all necessary parties aware. A ‘red, yellow, green’ concept may be used within the queue to show urgency levels of work. Red indicates the work item is overdue. Yellow indicates the work item is in danger of becoming overdue. Green indicates the work item is meeting expectations. Each work item displayed in an employee queue (e.g., end user, team lead, team manager, manager, director, administrator, resource manager) may be color coded so the priority of work is clear. For example, the end user queue might include only work that has been pushed or pulled to her individual queue, and each work item within that queue may be coded Red, Yellow, or Green. As another example, a manager's queue may include work items for all employees under her management, and color coded appropriately, so that the manager can visually determine which employees are falling behind.

Workflow module 407 also provides work queue statistics to administrators and managers in real time, based on an analysis of each employee's respective work queue. Thus, those who monitor the WMA 211 can see how many work items are being worked on, closed, held at any particular moment, assigned pending, and unassigned pending. Managers can thus review how many exceptions have been completed by individual, how many exceptions have been completed for any specific group of exceptions of work items, and the productivity levels by individual, exception type, and/or group of exceptions/work items.

Workflow module 407, in conjunction with SQL server 411, SQL reporting module 413, and/or database 419, may provide various reports to users upon request. Reports may be printed to an attached printer, or viewable online or on screen in a print-friendly format (e.g., .PDF). Reports can be generated using variable dates and/or times, e.g., based on start and end dates and/or times specified by a user or predefined in standard report templates (e.g., monthly, quarterly, annual, etc.).

Thus, users can easily identify high priority areas of work through reports. Workflow module 407 may use a baseline to recognize when a backlog condition exists. Workflow module 407 may determine a baseline based on historical data (e.g., previous two months of work), and may constantly modify the baseline as work continues. Alternatively, the baseline might always be created and/or adjusted manually by a user upon confirmation of appropriate data.

Workflow module 407 may also provide a ‘master’ queue of outstanding work. This ‘master’ queue provides visibility of each outstanding work item (e.g., each exception). When a work item is assigned to or pulled to an end user queue, that work item does not disappear from the ‘master’ queue. The items in this queue may be color coded to identify status. Workflow module 407 may also store a master audit trail for each workflow item/exception. An audit trail records every action performed in the workflow tool by a particular user or for a particular work item/exception. Actions include when a work item enters the WMA 211, when a work item is assigned to a queue, when a work item is opened by an end user, when a work item's status is changed, when a work item is being re-routed to another end user, and when a work item has been completed. Other data may also be tracked and stored, as desired. The workflow module 407 may make the audit trail available in real time for review or inspection by administrators and/or managers.

Workflow module 407 may create timestamps whenever certain actions are performed, and these timestamps may be used to create the audit trails. Timestamps may be stored with the exception or work item to which they pertain, or may be stored separately. Workflow module 407 may create a timestamp whenever an exception is created, i.e., the date and time that the work item enters the system. This timestamp is useful, e.g., when measuring cycle time. Another timestamp/userstamp may be created for a work item when it is first pushed to a user queue. This allows the WMA 211 to know when the work item is first assigned to a user so WMA 211 can measure how long the work item sits in the queue before being addressed by the user. Another timestamp is created when a work item is first addressed by a user. The first time the user addresses the work item is when the user first opens a work item. This timestamp is useful when measuring real time to complete work. This timestamp applies to both push and pull scenarios discussed above. Another timestamp/userstamp may be created each time the status of the work item is updated by the assigned user. That is, when the user does not have the work item open the clock is not ticking. Each time the user has the work item open the clock is ticking. This timestamp is thus useful when measuring real time to complete work. A work item is considered open if the end user performs some affirmative action indicative of the user working on a resolution for the work item/exception. Another timestamp may be created at completion of a work item, e.g., an exception is resolved. Completion of work item refers to the date and time that the work item is completed in WMA 211. The timestamp is useful when measuring cycle time and real time to complete work.

Workflow module 407 may generate a due date on all work items based on defined business rules. Due dates may be based on service levels, i.e., turn around times. Workflow module 407 may alternatively set up rules for determining each due date by business function. A due date may be determined by taking the date the work item is received and adding a predefined turnaround time to determine the due date. The due date may alternatively be determined by determining the bill cycle and setting the due date as the next scheduled bill date. Some business functions may have service levels determined by business days, others as calendar days, and others by hours. Some business functions may be stamped with a received date of Monday if the work item was received over the weekend. Some business functions may be stamped with a received date of Tuesday, for example, if the work item was received past noon on Monday.

Workflow module 407, using timestamps, tracks the time to complete work, e.g., resolved exceptions. The time to complete work may then be used as an input for productivity calculations. Workflow module 407 may also track cycle time of work. The clock starts when WMA 211 receives an exception and stops when the exception is resolved. Workflow module 407 may also have the ability to report productivity at various levels such as by date, individual, department, and/or business function. Productivity may be defined as the rate at which a user is performing work compared to the rate at which they are expected to complete work. Productivity levels may include date, individual, department, and business function and these levels may be combined in one report or provided in separate reports. For example, one report might include productivity by individual for a specific date range. Another report might include productivity by client. Workflow module 407 may also report utilization/adherence at various levels such as by date, individual, department, client, and business function. Utilization/adherence refers to the scheduled time in day for a user compared to time in the day accounted for by that user. Various levels may include by date, individual, department, client, and business function.

Workflow module 407 also provides the ability to report statistics for volumes and cycle time. Workflow module 407 also provides the ability to track users' time in day even when not actively working in the WMA 211. For example, workflow module 407 may provide a ‘hot button’ feature (similar to a “make busy” button) that a user can activate to indicate he or she is now doing something else (phone call, meeting, washroom, assisting peers, etc.). At the time the end user is leaving exception resolution to do something else, the user indicates what exception activity she will be performing by clicking on a drop-down box or radio button for acceptable exception types. The workflow module 407 tracks the time from when the user leaves to when the end user comes back to the workflow module 407 for another function.

Workflow module 407 also provides the ability to report actual cycle time by business function. That is, for each business function the workflow module calculates and provides actual cycle time by work item. Workflow module 407 also provides the ability to report how many work items were received by business function, with the percentage completed by a predefined required/desired turnaround time. Workflow module 407 may also provide the ability to provide input of completed work items performed by CSRs who are ‘pulling work from a queue as described above to report idle time utilization.

Workflow module 407, in conjunction with security module 405 and database 417, provide various security features for WMA 211. Security features include the use of security levels (e.g., administrator, department manager, team manager, team lead, end user, etc.). Based on these security levels, the workflow module 407 may determine the level of access/authorization for each user within the WMA 211 and what permissions each user has (e.g., view only, create, modify, delete, etc.).

WMA security 405 also includes the ability for each user to log in with a user ID and password, e.g., using Microsoft Windows integrated authentication in conjunction with Active Directory. Similarly, administrators can control individual and group settings, also using Microsoft Windows integrated authentication in conjunction with Active Directory.

Using workflow module 407, WMA 211 also provides the ability to track inflow volumes of work at various levels. Inflow refers to work items that are newly received. Tracking levels include by date, individual, department, client, business function, or a combination of several of those criteria. Similarly, workflow module 407 also provides the ability to track outflow volumes of work at various levels. Outflow refers to the work items that are newly completed. Tracking levels include by date, individual, department, client, business function, or a combination of several of those criteria.

Workflow module 407 may also provide the ability to track outstanding volumes of work at various levels. Outstanding refers to the work items that have been received but are yet to be completed. Tracking levels include by date, individual, department, client, business function, or a combination of several of those criteria. Using workflow module 407, administrators and/or managers may have the ability to view real-time volume information online. Volumes information refers to numbers of inflow, outflow, and outstanding work items. The numbers of volumes may be updated and displayed in real-time.

Using the reporting modules, workflow module 407 also provides the ability to graphically report volumes of work items at various levels. Volumes includes inflows, outflows, and outstanding work items, and reporting levels may include by date, individual, department, client, and business function. The report may be displayed in graphical format for easy analysis by end users.

Workflow module 407 may also track an individual's client billable time. Client billable time may occur when end users are pulled off their normal backoffice work to be part of a project. Project work may be billed as discretionary time and therefore may be tracked separately. Workflow module 407 may also track non-business function time. Non-business function time may include meetings, vacations, training, etc. Both business and non-business time may be tracked in WMA 211 so complete utilization of users can be reported.

Workflow module 407 also provides various other reports, e.g., aging of volumes of work items by business function. Such a report might include items in categories of 30, 60, and 90+ days old. Other ages can be used. Another report might be business functions with a spike in volume. This report may be used to trigger root cause analysis outside of the WMA 211.

As indicated above, WMA 211 tracks and records audit trails. Workflow module 407 provides the audit trail for quality auditing purposes, among other uses. The audit trail indicates what work each user performed and therefore management can easily review for quality auditing purposes.

Workflow module 407, in combination with admin module 403, provides various administrative features and functions. Administrators can add, delete, and update skill sets for users and types of exceptions. Each user and/or exception may be assigned a primary and secondary skill set. Similarly, administrators maintain user information, e.g., adding, deleting, editing user information and passwords. Administrators also use workflow module 407 and admin module 403 to maintain user schedules. User schedules may be stored in database 419 or in some other database. The administrator can store the list of users, vacation calendar, shift, flex hours, skill sets, and can update schedule, unplanned absence, and unscheduled activity. The administrative features also allow a user to customize presented information based on business function type, and to customize the user interface to meet business needs. That is, the User Interface (UI) may be modified to suit the business environment in which WMA 211 is in use. For example, queues display each work item color coded according to risk of meeting SLA.

Workflow module 407 may also provide usability features, such as a search feature through which a user can keyword searches to find specific work items. A user may need to search by account number, customer name, street address, or client in an effort to find a pending or completed work item. Searches may be conducted by a string of words, numbers, wild cards, etc., as is known in the art. Users may also add comments on work item records, e.g., to note work completed or to indicate why an exception was not resolved.

Upon logging into the WMA 211, workflow module 407 displays a user's assigned work queue. The user can change the status of any work item, as applicable, and workflow module 407 tracks status changes as indicated above. Statuses may be configurable by an administrator. Examples of status include Unassigned, Assigned, Escalated, Needs Investigation, Pending Investigation (looked at but awaiting information), Being Worked, etc. The status of a work item may change automatically when the work item is pushed to an end user queue (Unassigned becomes Assigned), when the work item is pulled to an end user queue (Unassigned becomes Assigned), or when the work item is first opened by an end user (Assigned becomes Being Worked). Other automatic status changes may also be used, based on business processes and workflow. In addition, an administrator can specify sequencing of statuses in the WMA 211, and statuses cannot progress contrary to the predefined sequence(s). Thus, while a work item is under one end user's name the status might only change in a pre-defined sequence. For example, if the status of a work item is ‘Pending Investigation,’ the system might not allow the user to manually change the status to ‘Assigned,’ which is defined as being earlier in the status sequence.

Workflow module 407 may indicate to an end user that a work item in a queue is being worked on by someone else. This avoids duplication of effort and therefore wasted time. Workflow module 407 may also indicate which end user is working on a work item when an end user clicks on a work item. Users can also search pending work. This functionality allows users to search through work items that have not yet been accessed by an end user. For example, until an end user enters the account number for the piece of received correspondence WMA 211 might not include the correspondence in search results.

Workflow module 407 may also allow users to search pending work to open in a view only mode. When a work item is retrieved in view only mode the workflow history of the action on this work item is provided.

Users can manually create new work items using templates, if needed, e.g., based on manually received exceptions. This replaces the need to use email when backoffice work is received by the call center as the result of a customer call. There may be pre-determined exception types that an end user selects when creating a new work item and that exception type determines the newly created exception's priority and routing.

As with existing work items, users can add comments in newly created work items, e.g., to indicate how the new work item was received, or any miscellaneous information about the new work item, such as that provided by a customer via a telephone call. When a user creates a new work item using a template the user can write free-form text in a comments field so the recipient user understands the details of the work item.

Workflow module 407 also provides the ability to display other work items pending for the same account and/or customer name associated with the work item that an end user is working on. This provides the benefit of knowing what other actions may be occurring on the same account/customer that is being worked. For example, an end user opens a billing exception work item and immediately sees a dialog box display of any other pending work items for that same account/customer.

The workflow module 407 may provide other features, such as the ability for an end user to access a knowledge base of help files. The knowledge base may deal specifically with the WMA tool 211. Context-sensitive help files within the knowledge base may be specific to workflow and may be displayed by providing predefined input, e.g., a “?”, over or near the questionable area or field. Workflow module 407 also provides the ability to copy and paste data between applications, including between WMA 211 and legacy applications executing on the same computer. Allowing easy copying and pasting of data speeds up processing times by reducing the need to move back and forth from a legacy application and WMA 211.

In addition, users can select multiple work items for batch editing and/or updating of multiple work items concurrently. A user can thus correct scanning or other errors and change statuses on multiple work items. Effecting changes concurrently allows for quick error recovery and more efficient re-assignments of work, among other benefits. Changes are reflected in the appropriate databases in real time. Changes can also be made to existing work items. Changes to work items may include those that have not previously been worked as well as those that have.

Certain fields in the user interface may be required, and workflow module 407 and/or UI module 401 may validate user input of required fields, as well as ensure that input in other fields meets any predefined input criteria (e.g., numbers, phone numbers, names, format, etc.). WMA 211 may pre-populate certain fields with default values based on exception type, employee identification, date, manually entered data in other fields, etc., which an employee may or may not be able to change if desired.

Even after work items have been closed (e.g., exceptions have been resolved), managers or other personnel having appropriate permissions and security rights can view historical details of work items. Similarly, personnel can update work items even after they have been closed, if necessary.

Other miscellaneous features provided by WMA 211 and workflow module 407 include the ability to archive inbound customer correspondence for a predefined configurable retention period, and the ability to retrieve archived inbound customer correspondence. In some cases, there may be a complaint which warrants retrieval of the archived correspondence. The system also provides the ability to archive lists of work items, e.g., for auditing purposes. The system similarly allows users to retrieve archived work item lists. In all archival cases, the users and/or company can define business rules and criteria for archival and retention periods.

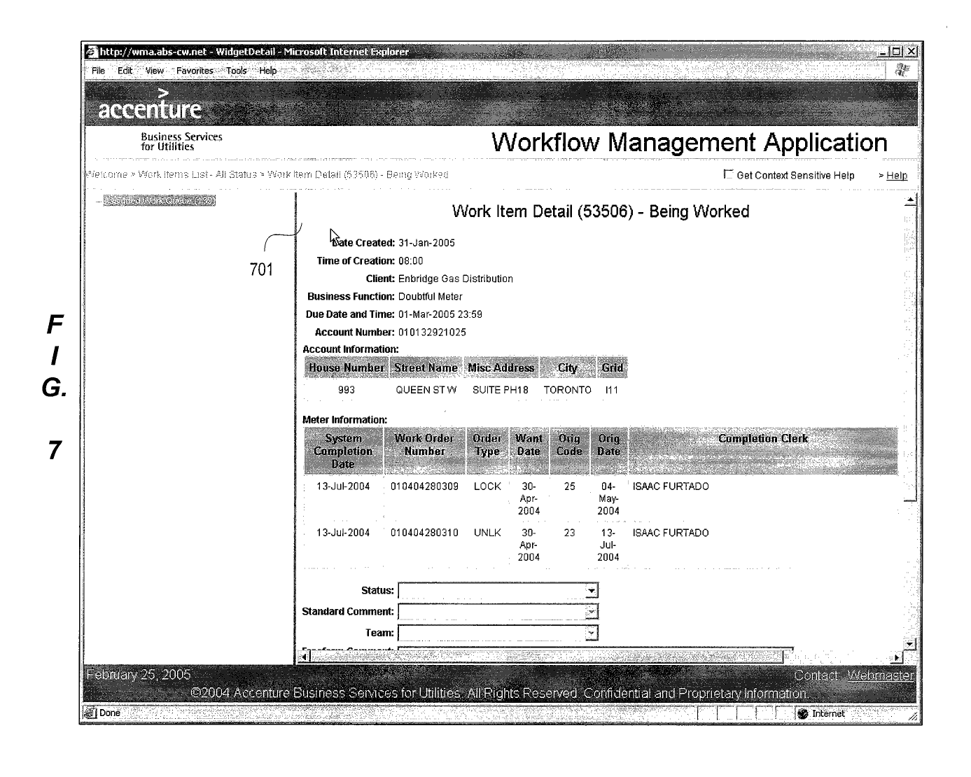

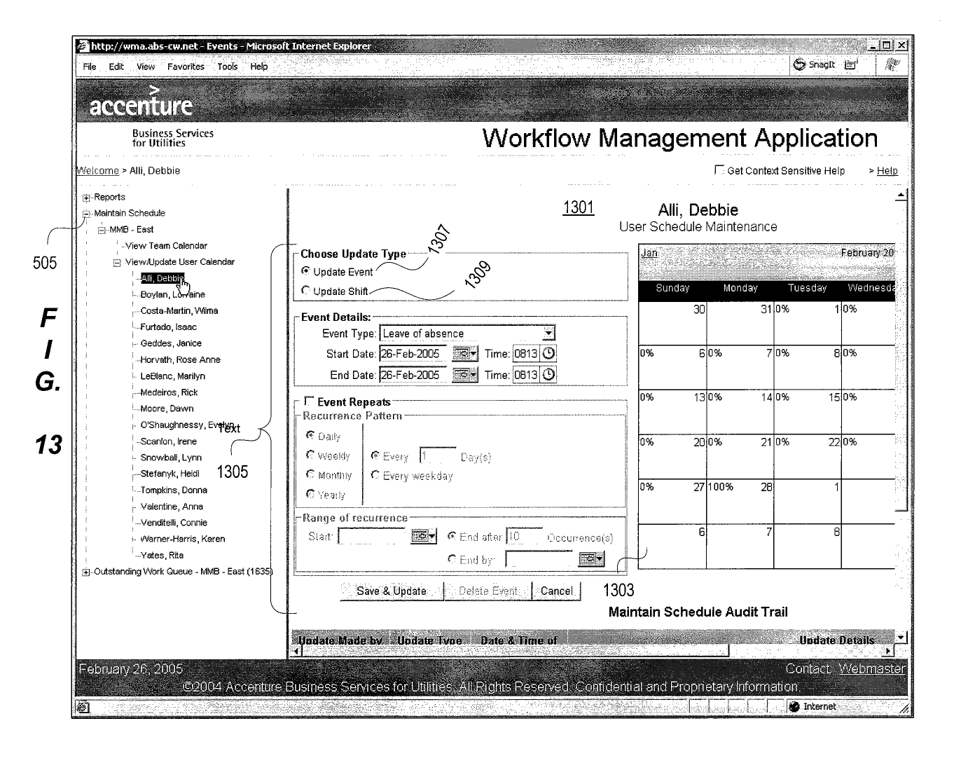

FIG. 5-FIG. 31 illustrate screenshots of illustrative aspects described herein according to an illustrative embodiment of the invention. FIG. 5-FIG. 10 illustrate representative screen shots for an end user whose principal responsibility is the resolution of work items. FIG. 11-FIG. 31 illustrate representative screen shots for management or supervisory personnel. The illustrated screenshots are representative examples only, and are not intended to be limiting in any respect. The screenshots represent illustrative views taken from a working prototype of the invention under internal development and using historical data for testing purposes.

FIG. 5 illustrates a screenshot for a welcome screen 501 for an end-user upon successful login to WMA 211. Each screen may include a menu region 503, which displays a menu tree 505 navigable by the user, and a data region 507 which displays data based on the user selecting a menu item in menu region 503.

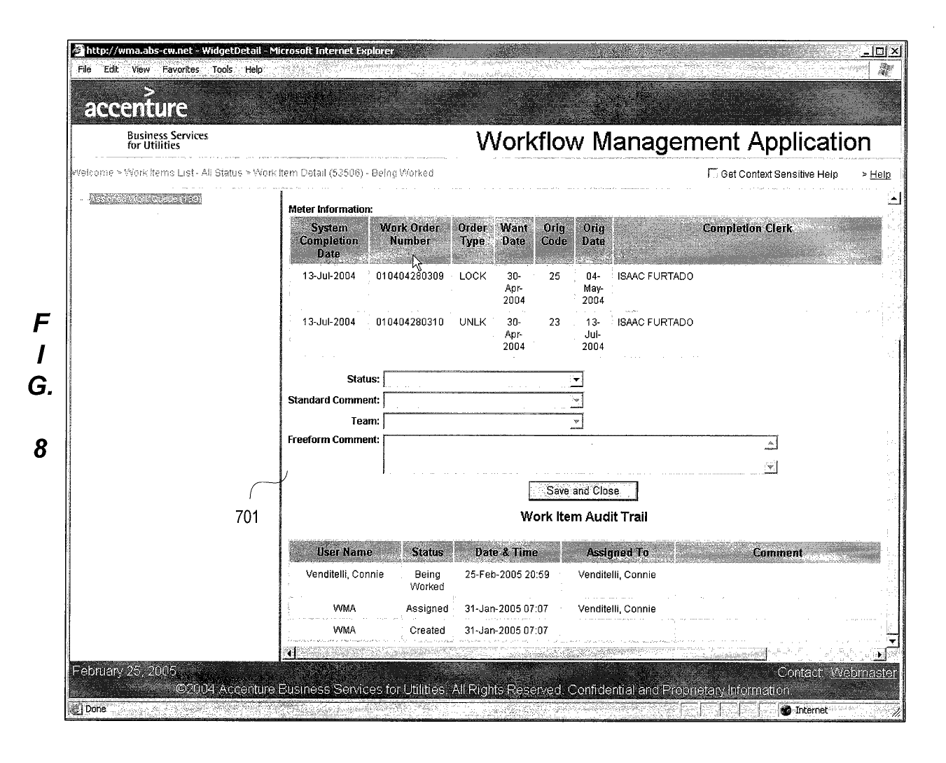

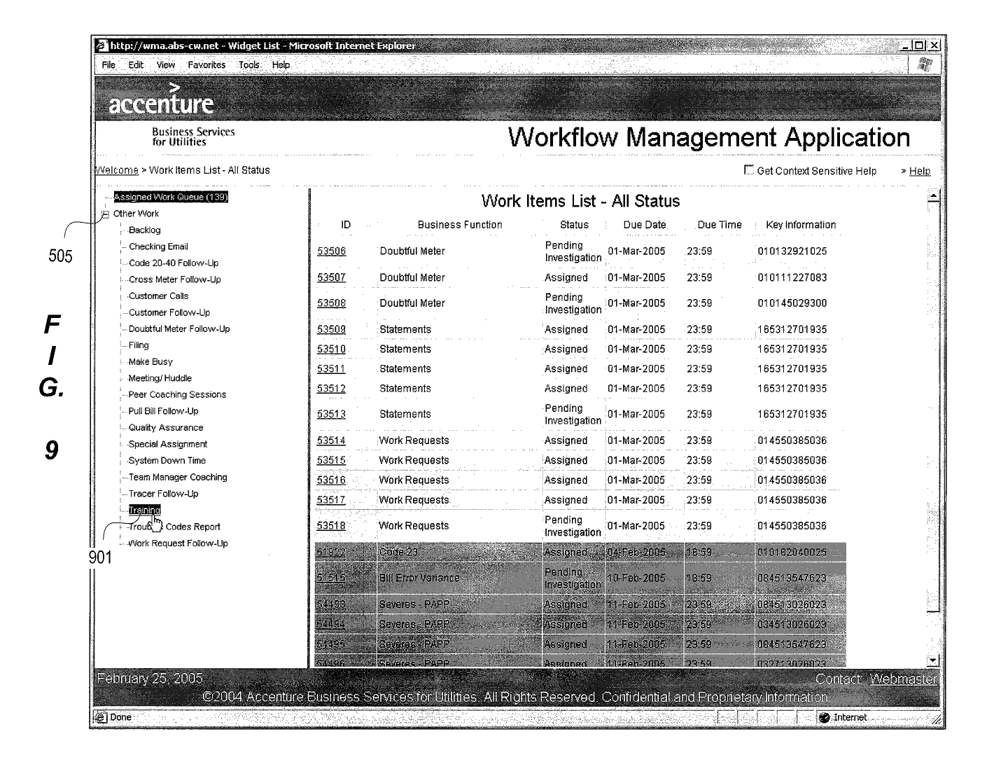

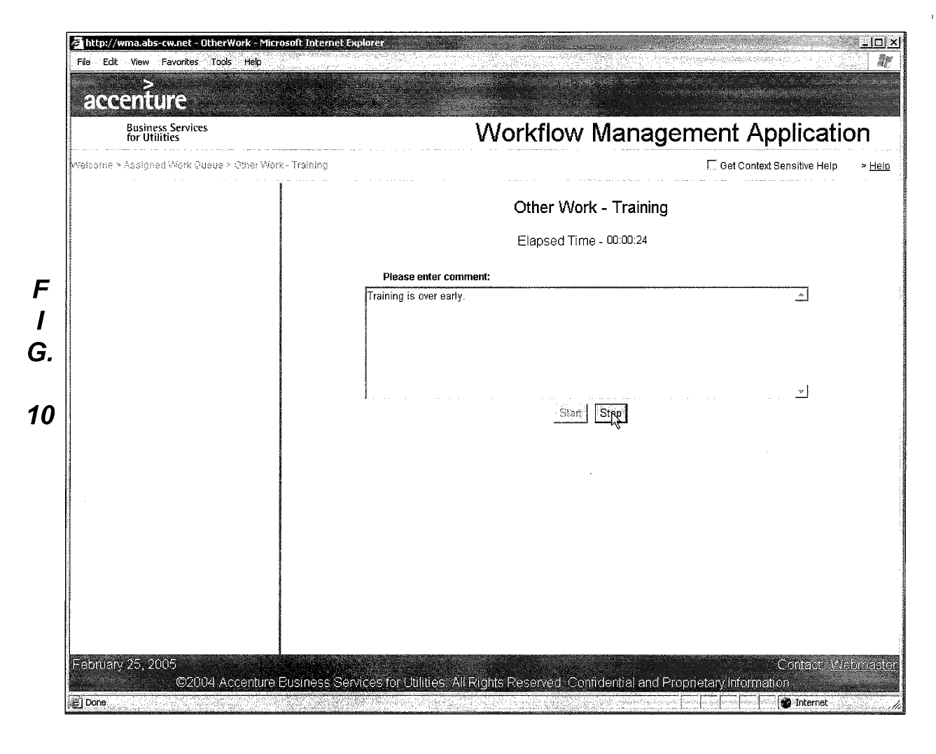

FIG. 6 illustrates a primary work queue 601 for the end user, which may be displayed automatically by WMA 211, or displayed upon request by the end user after logging in. Upon selection of a work item, e.g., item 603, WMA 211 displays a work item detail screen 701, such as that illustrated in FIG. 7. FIG. 8 illustrates work item detail screen 701 upon the user scrolling down from FIG. 7 to view the remainder of the work item detail screen 701.

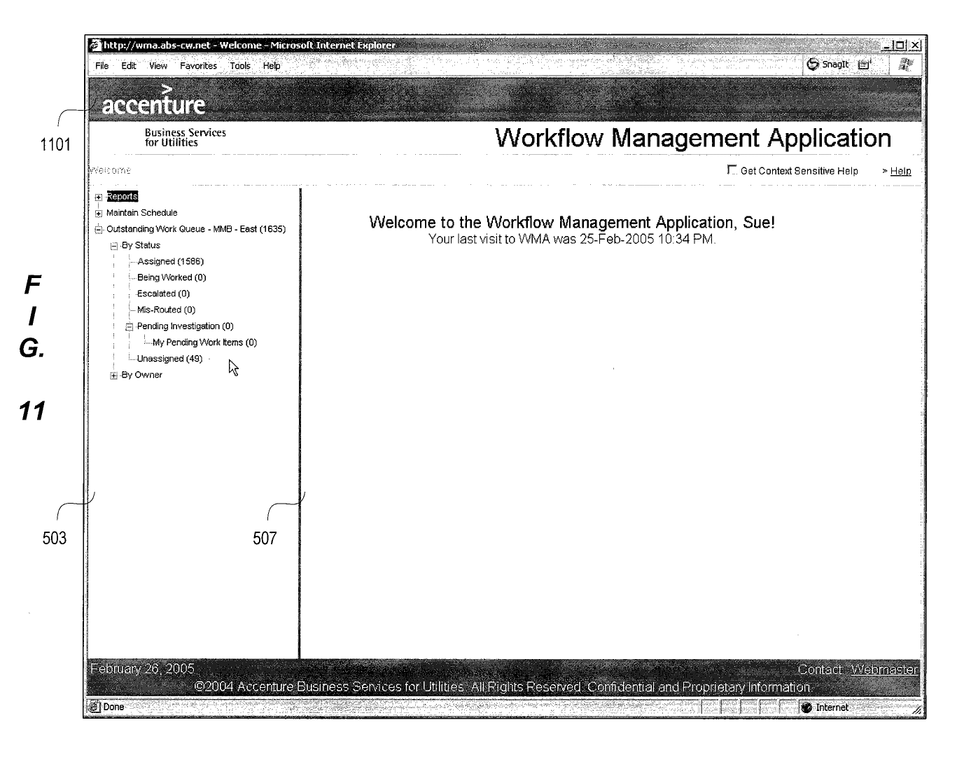

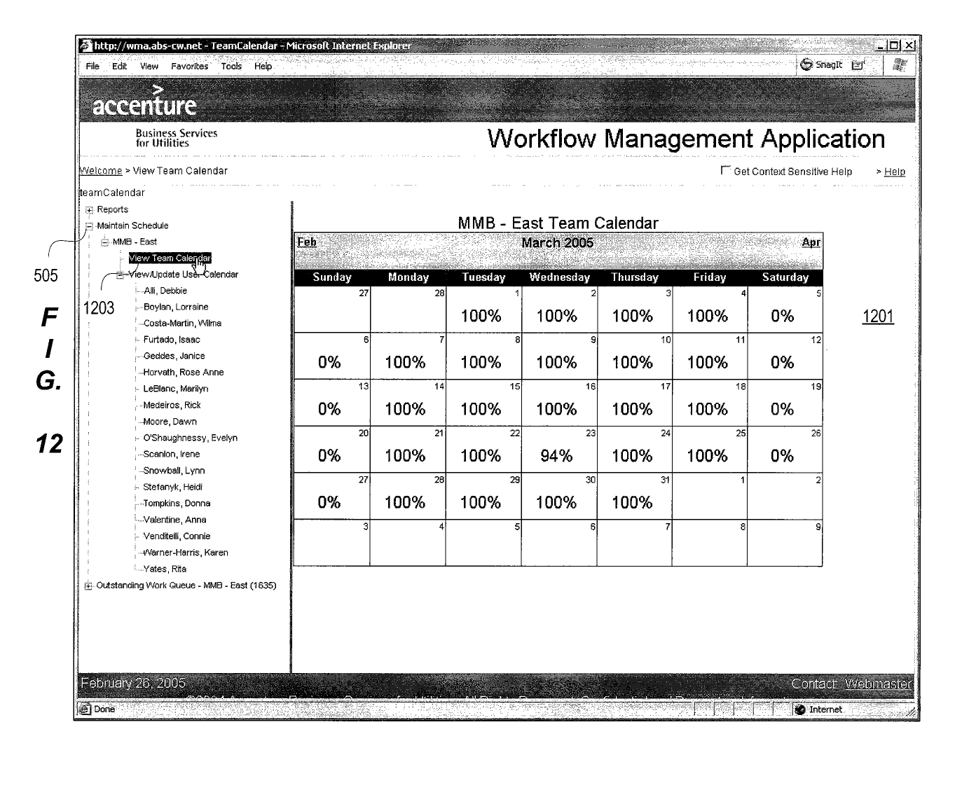

FIG. 9 illustrates a similar view as in FIG. 6 after the user has expanded the menu item ‘Other Work’ in menu tree 505. The user selects ‘Training’ 901 to indicate the user will begin a training session instead of working on the resolution of work items (exceptions). WMA 211 may then present an Other Work screen 1001 illustrated in FIG. 10, and start a time. In FIG. 10, the user has indicated that training has ended early, and presses the Stop button to return to his or her queue of work items 601, e.g., as illustrated in FIG. 6.

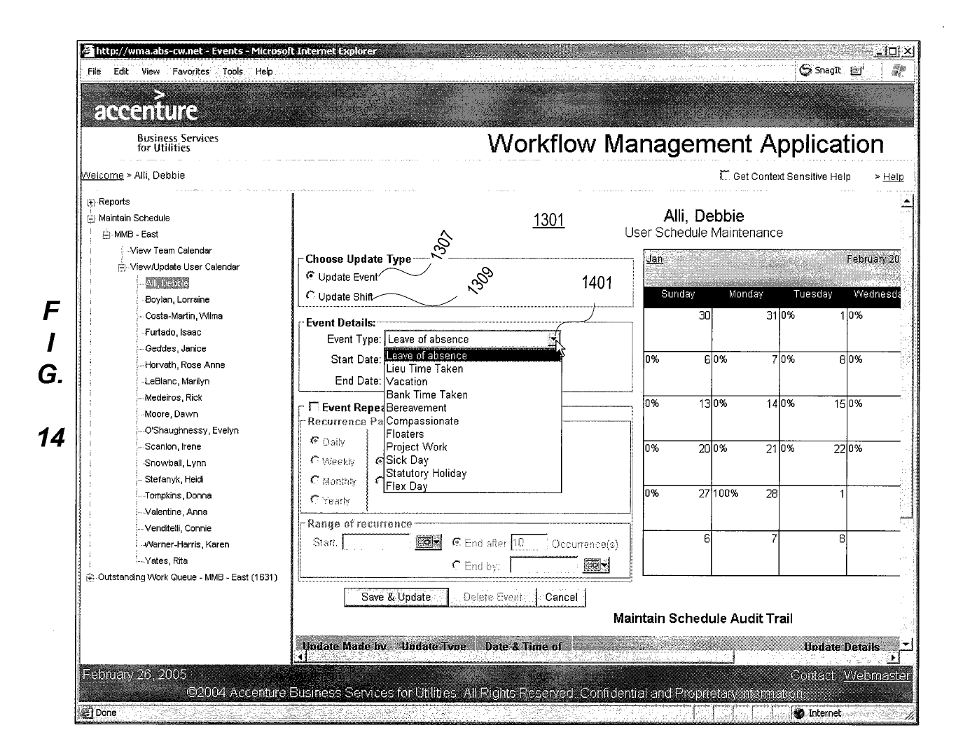

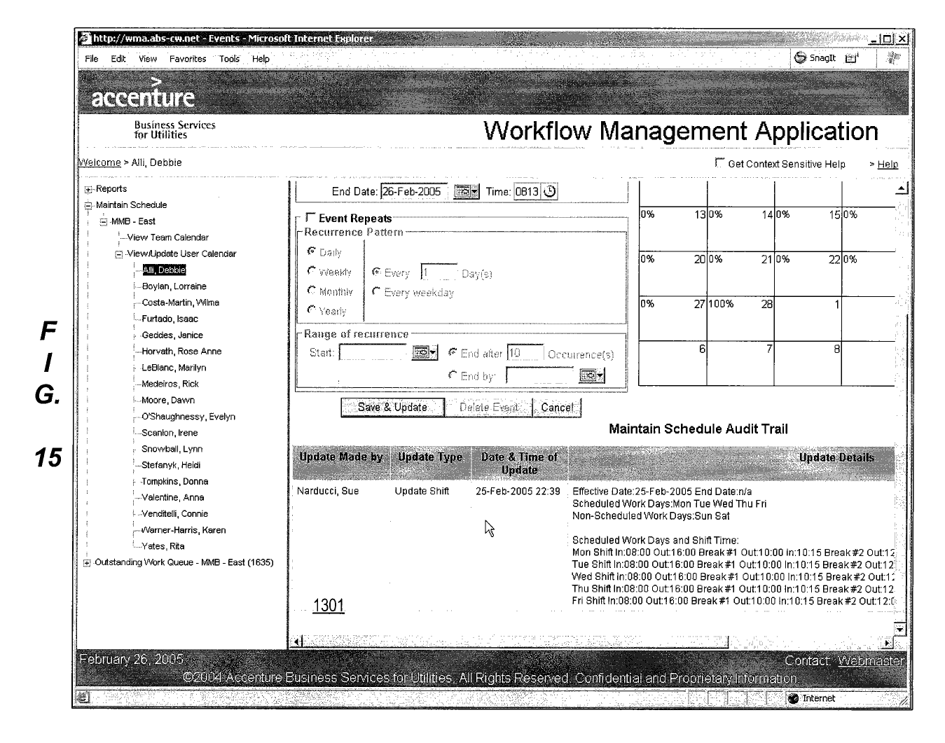

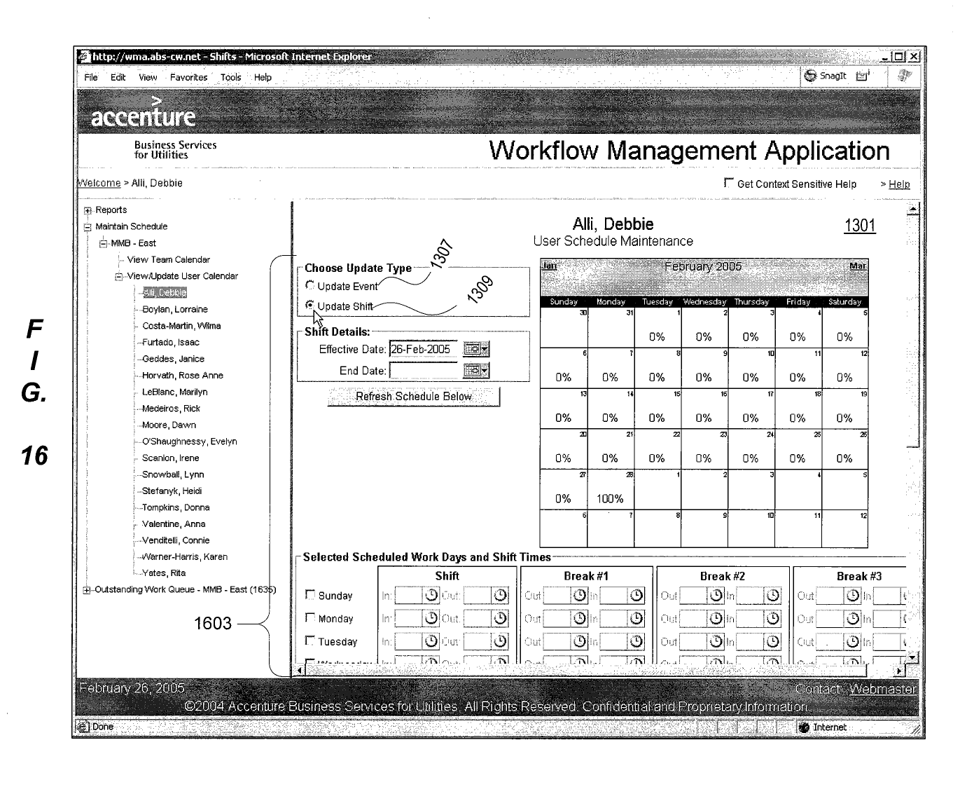

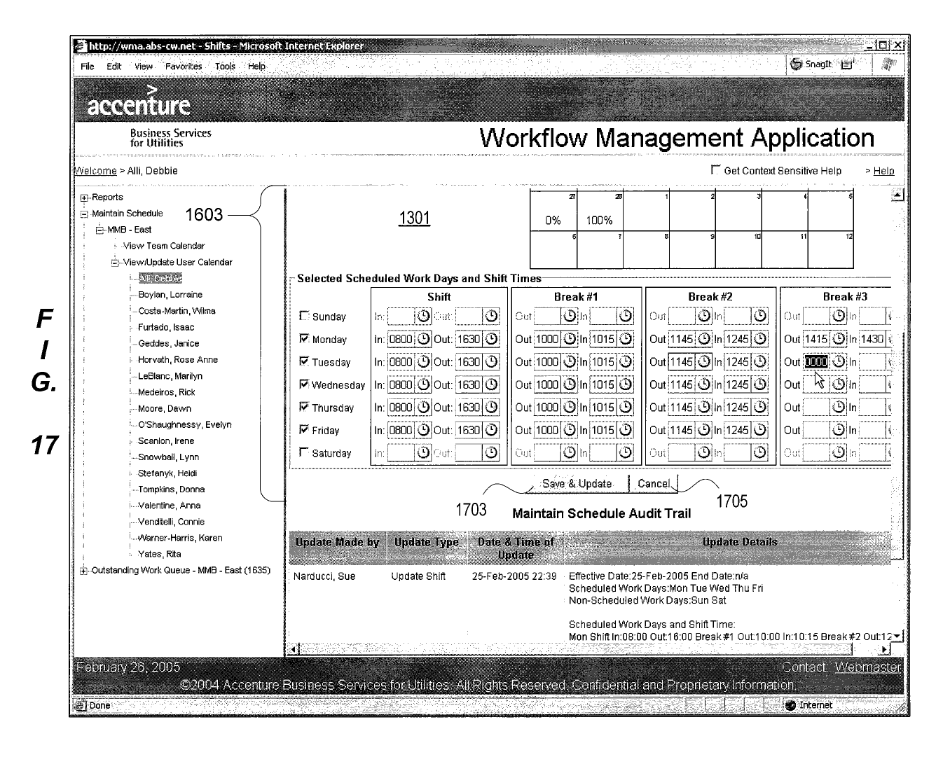

FIG. 11 illustrates a management welcome screen 1101 for user with additional security and/or privileges upon successful login to WMA 211. Such screens similarly have a menu region 503 and data region 507. FIG. 12 illustrates a team calendar screen 1201, upon selection of the team calendar item 1203 from menu tree 505. The percentages in FIG. 12 indicate the percentage of a person's scheduled time in a given day that is available for that person to perform work routed to them by the workflow management tool described herein. For example, if a person is scheduled to work 7 hours and that person is scheduled to have 2 hours of training that day, then that person's percentage is 5/7, or 71%. FIG. 13 illustrates a user schedule maintenance screen 1301, displaying a user calendar 1303 upon selection of the user Debbie Alli under the Maintain Schedule/MMB-East/View-Update User Calendar option on menu tree 505. Along with user calendar 1303, user schedule maintenance screen 1301 provides options 1305 through which a manager or other user with appropriate privileges can update information regarding the selected user, such as updating the user's shift 1307, or updating an event 1309 corresponding to the selected user. Options 1305 correspond to the Update Event option 1309. FIG. 14 illustrates the manager user selecting drop down list 1401 (Event Type) to select a type of even after selecting the Update Event 1309 option. Upon updating the schedule of the selected user (Debbie Alli), WMA 211 updates the audit trail to indicate which user updated the schedule, and what changes were made. FIG. 15 illustrates user schedule maintenance screen (scrolled down from the view in FIG. 13) showing the audit trail based on the schedule update completed in FIG. 14.

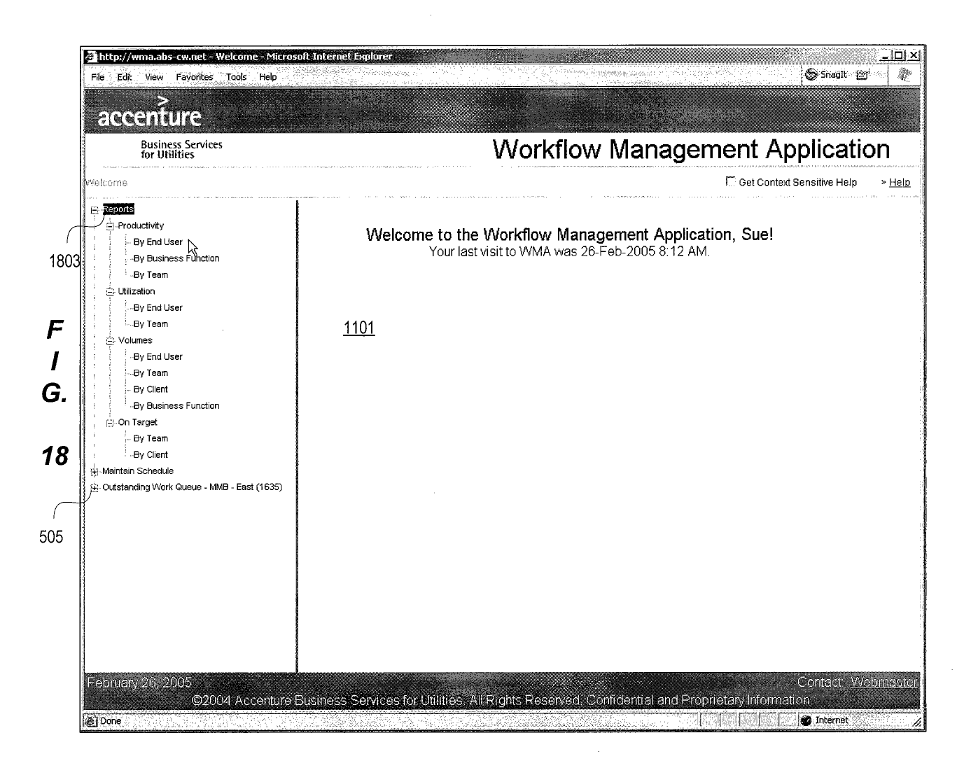

FIG. 16 illustrates user schedule maintenance screen 1301, where the manager user has selected the Update Schedule option 1307. User schedule maintenance screen include option 1603 which correspond to the Update Schedule option 1307. Upon selecting Update Schedule 1307, the user can define a new schedule in the Selected Scheduled Work Days And Times area in the lower portion of options 1603, further illustrated in FIG. 17. Upon entering any desired schedule changes, the manager/administrative user can save/update 1703, or cancel 1705.

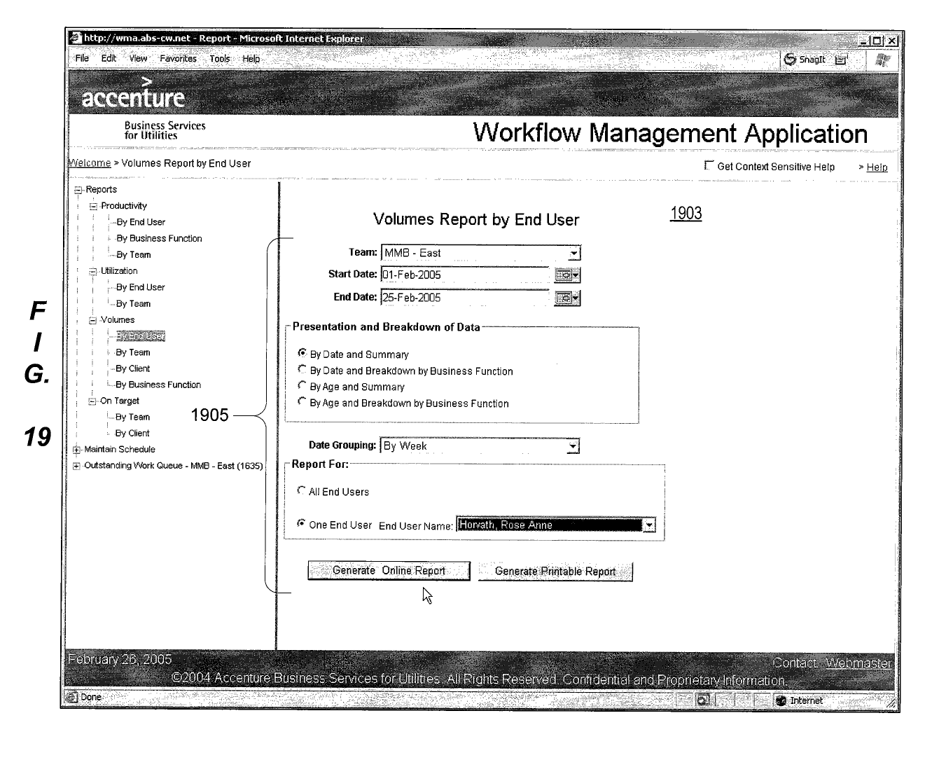

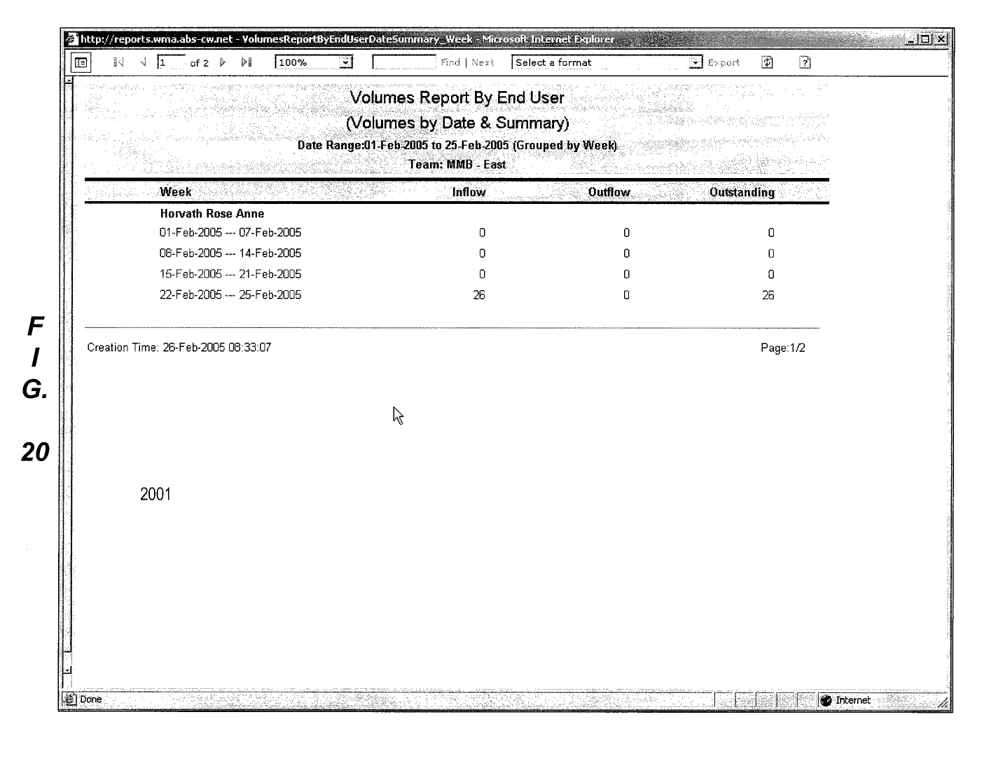

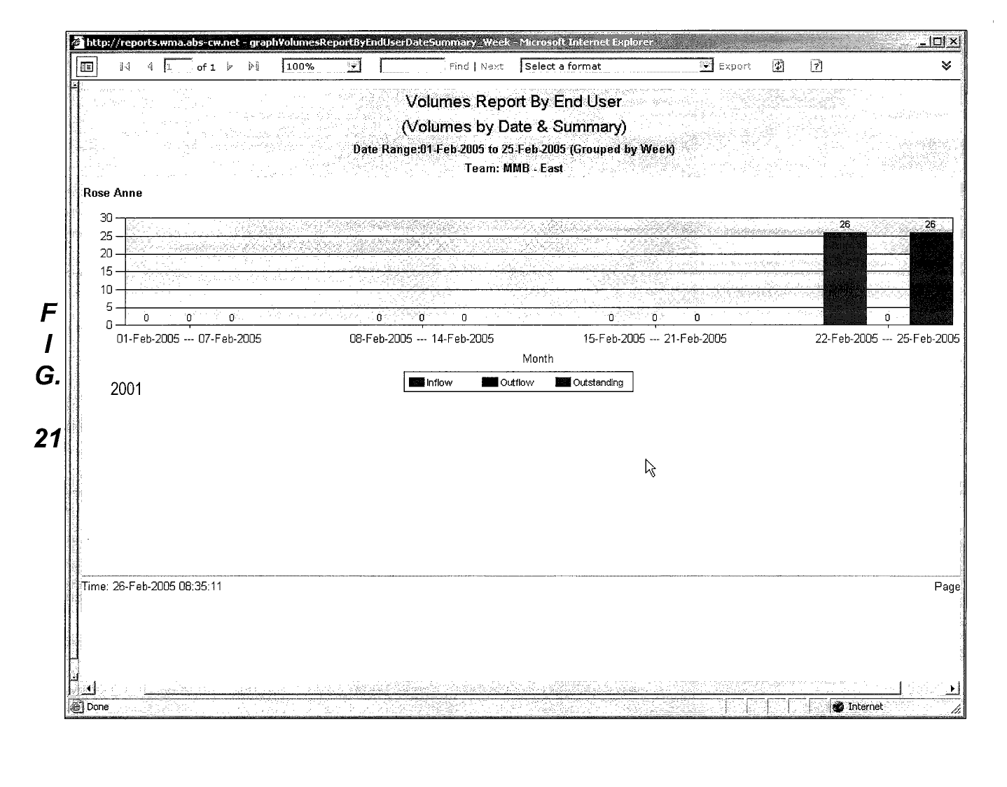

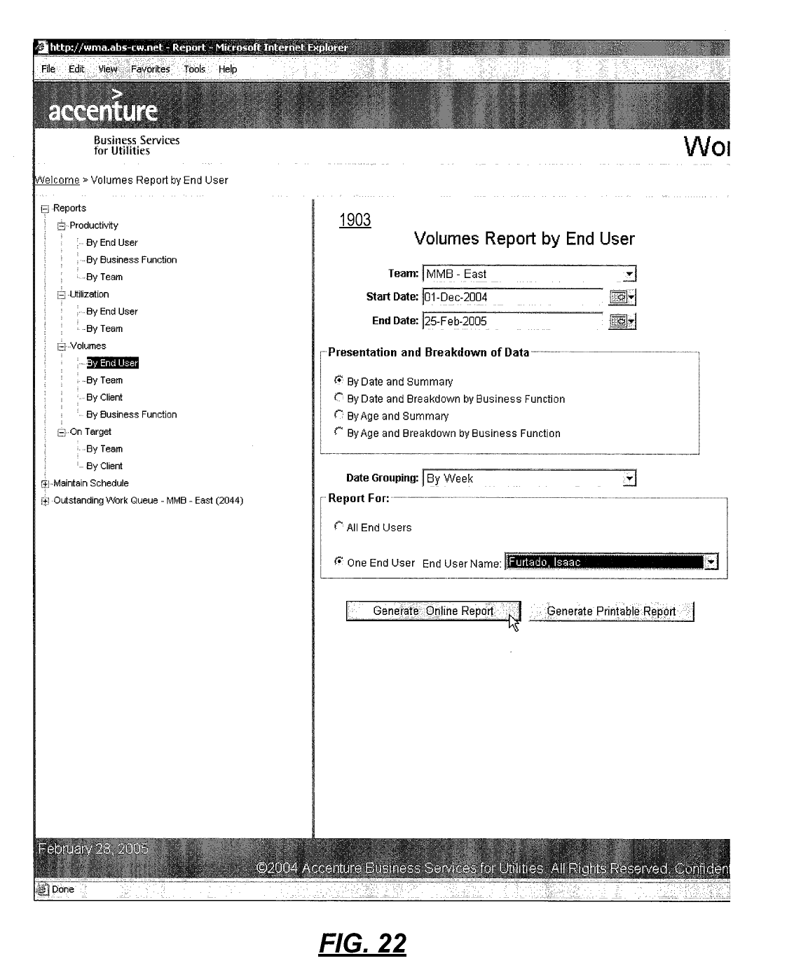

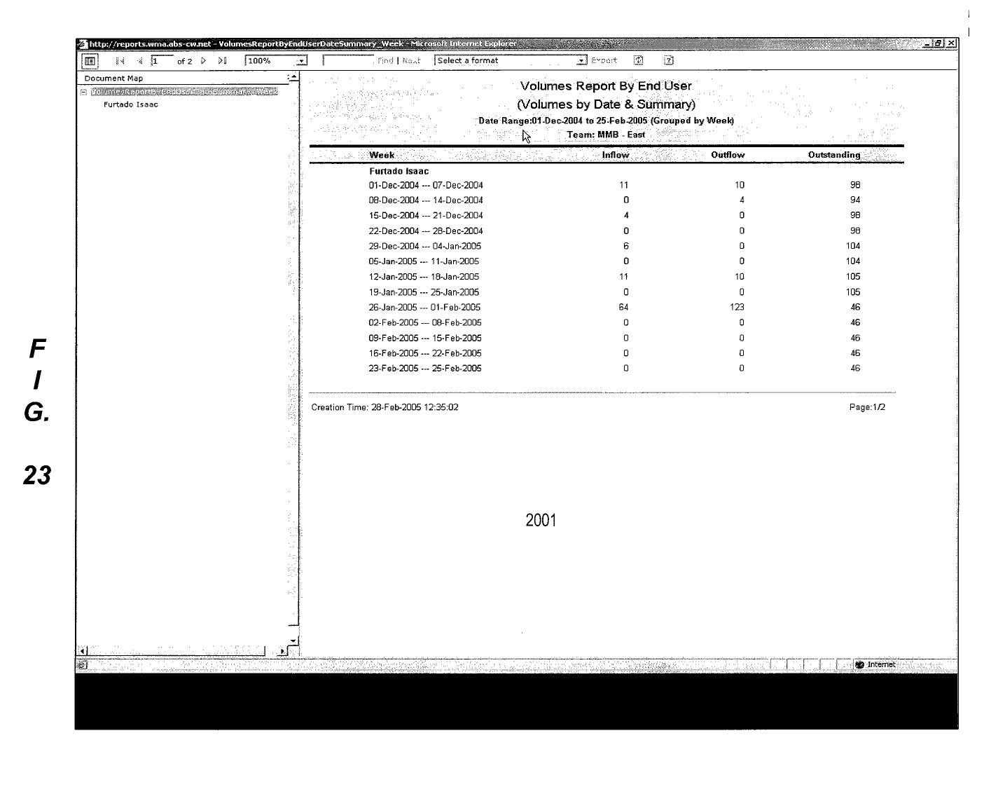

FIG. 18 illustrates the welcome screen 1101, where the user is selecting the Reports option 1803 from menu tree 505. As shown in FIG. 19, menu tree 505 expands, and the user selects Reports/Volumes/By End User. WMA 211 then displays the Volumes Report By End User settings screen 1903, where the user can provide options 1905 to define the scope of the desired report. Upon entering the desired options and selecting the Generate Online Report button, the first page of the Volumes Report By End User 2001 for user Rose Ann Horvath is displayed in FIG. 20. The second page of the Volumes Report By End User 2001 for user Rose Ann Horvath is displayed in FIG. 21. The user also has the option from FIG. 19 to generate a printable report. Other reports provide similar options, as appropriate, as illustrated in FIG. 19 for the Volumes Report By End User. FIG. 22 illustrates Volumes Report By End User settings screen 1903, where the user is selecting a different user (Isaac Furtado) for which a report is desired. FIG. 23 illustrates page 1 of the corresponding Volumes Report By End User 2001 for Isaac Furtado.

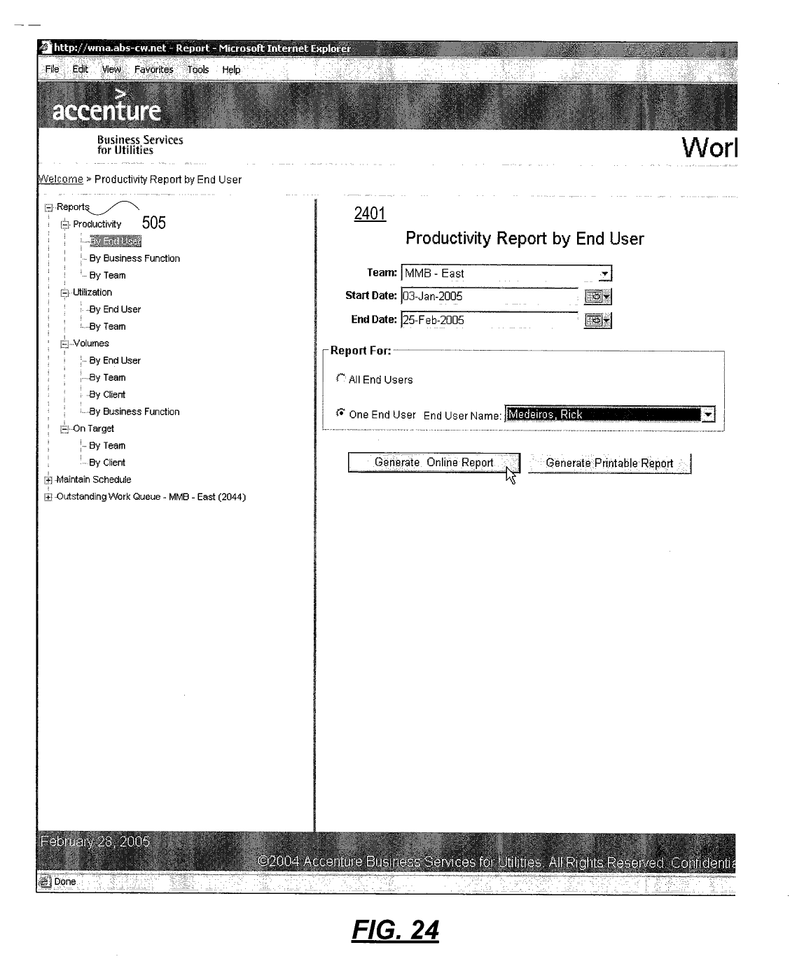

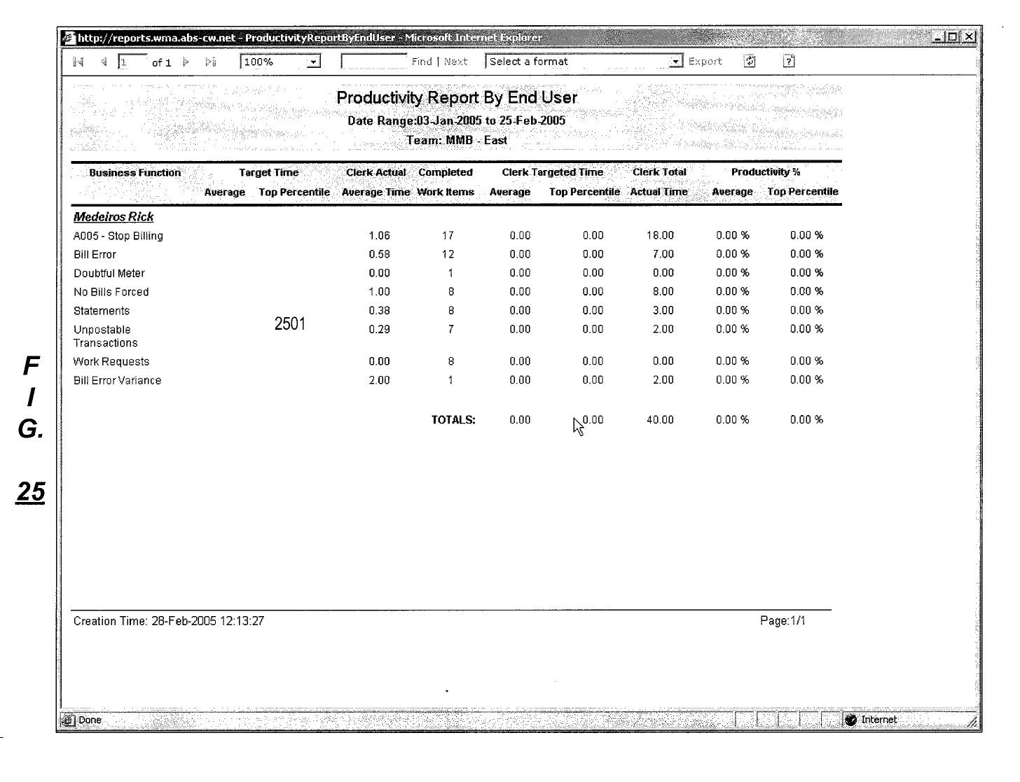

FIG. 24 illustrates the options screen 2401 when Productivity Report By End User is selected from menu tree 505. In this example, the user inputs a desired team and date range, and then selects the desired user (Rick Medeiros), and selects the appropriate button to Generate Online Report. FIG. 25 illustrates the Productivity Report By End User 2501 for Rick Medeiros for the desired date range.

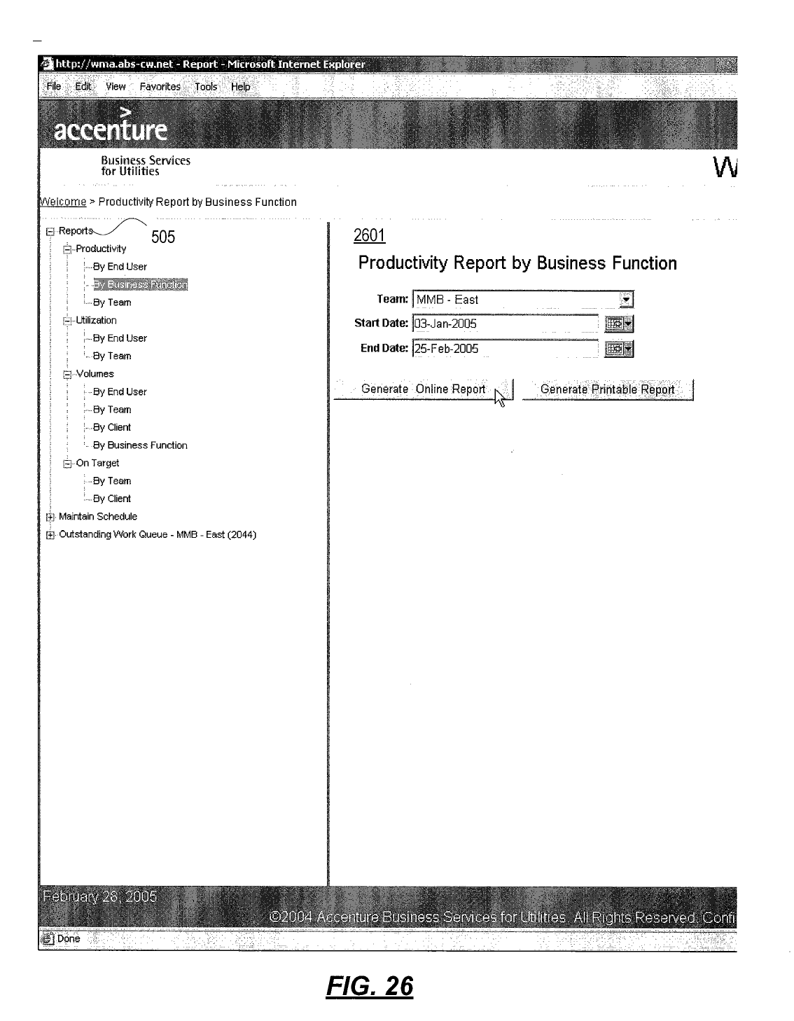

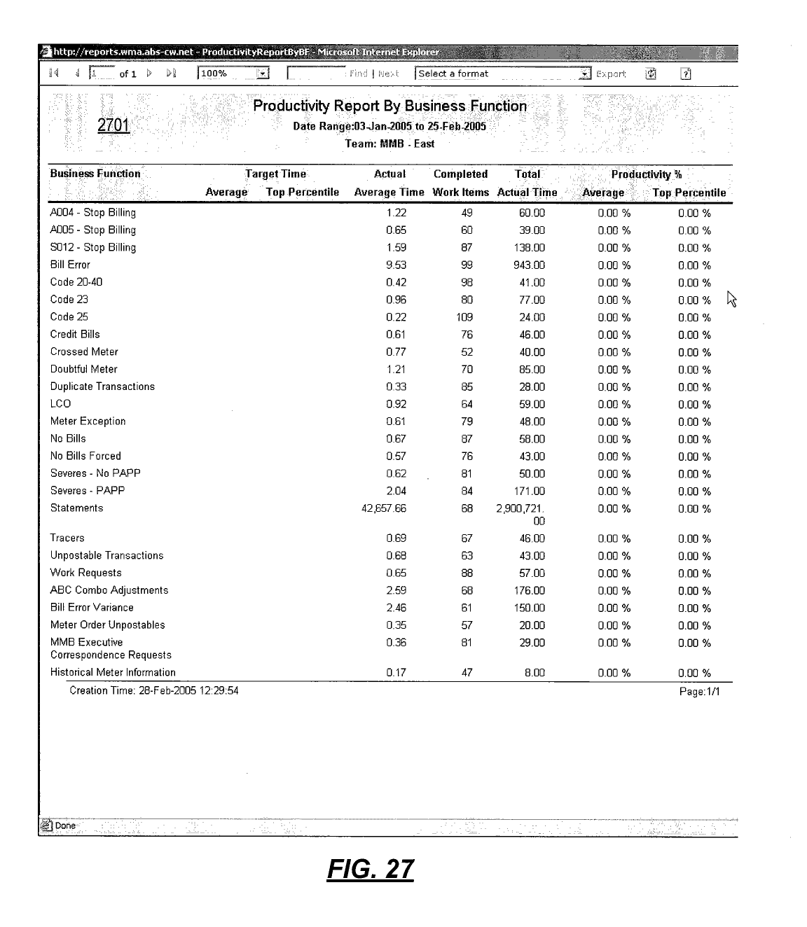

FIG. 26 illustrates the options screen 2601 when Productivity Report By Business Function is selected from menu tree 505. In this example, the user inputs a desired team and date range, and then selects the appropriate button to Generate Online Report. FIG. 27 illustrates the Productivity Report By Business Function 2701 for the desired date range.

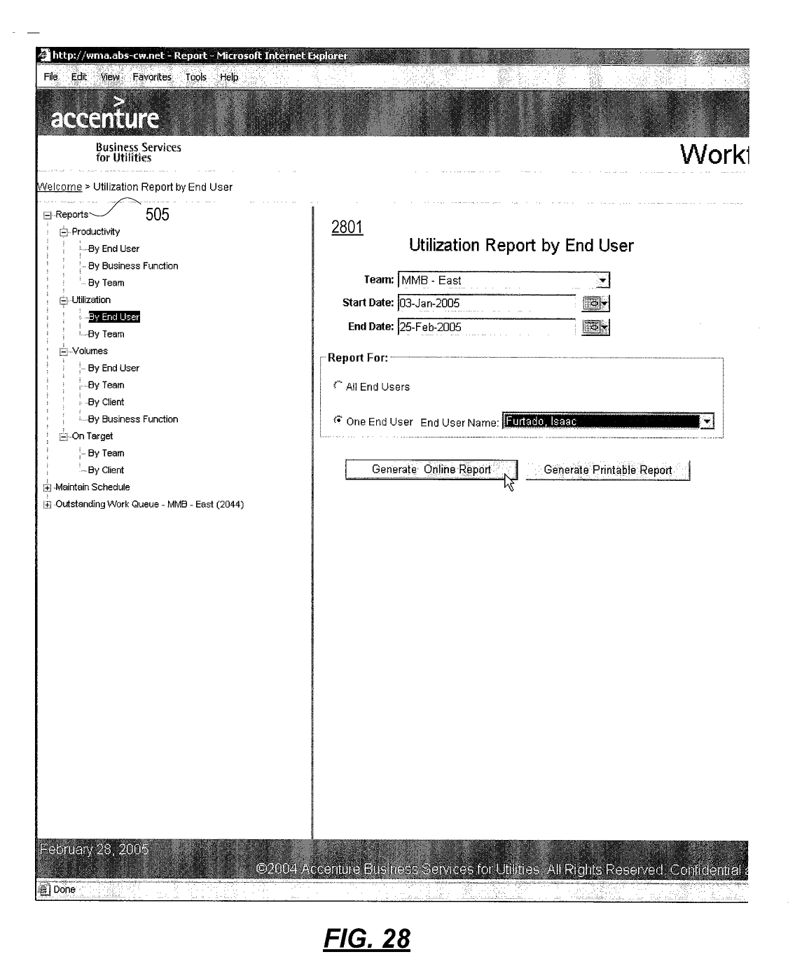

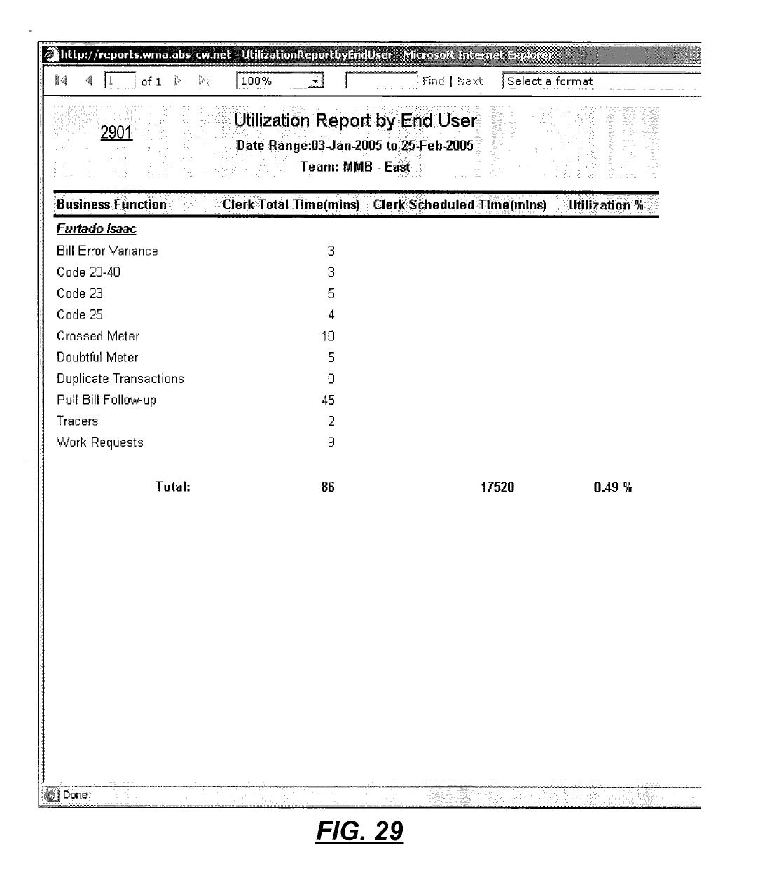

FIG. 28 illustrates the options screen 2801 when Utilization Report By End User is selected from menu tree 505. In this example, the user inputs a desired team and date range, and then selects the desired user (Isaac Furtado), and selects the appropriate button to Generate Online Report. FIG. 29 illustrates the Utilization Report By End User 2901 for Isaac Furtado for the desired date range.

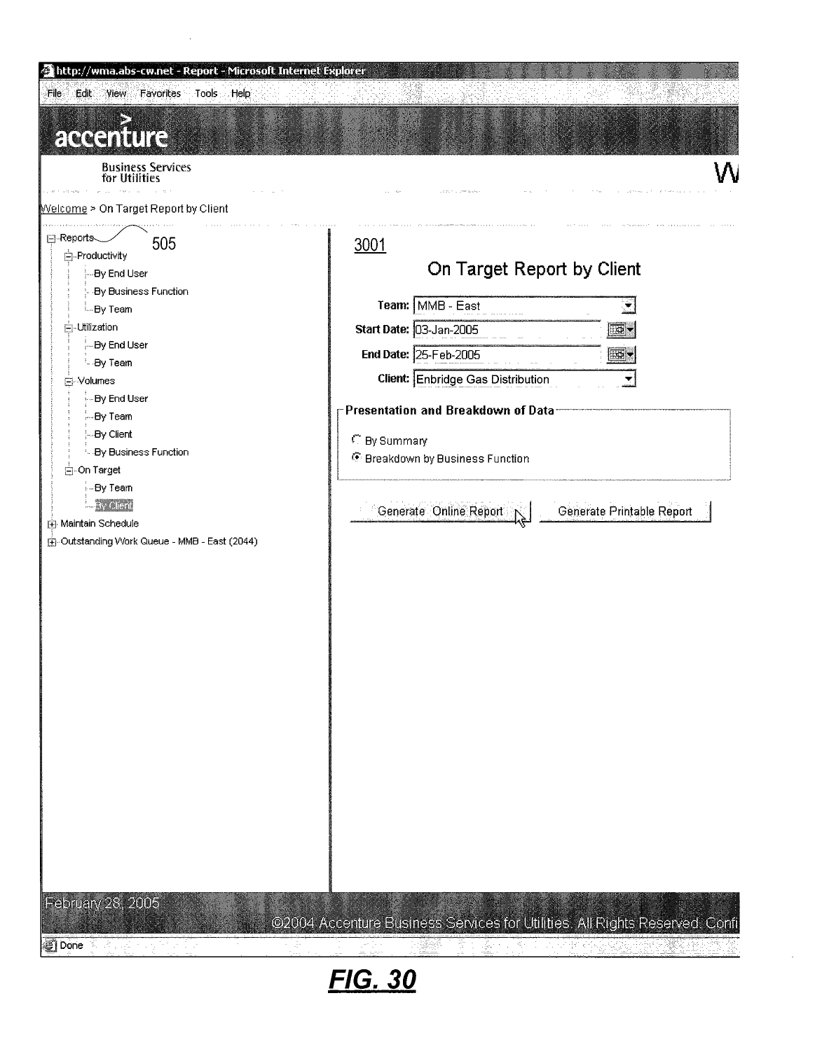

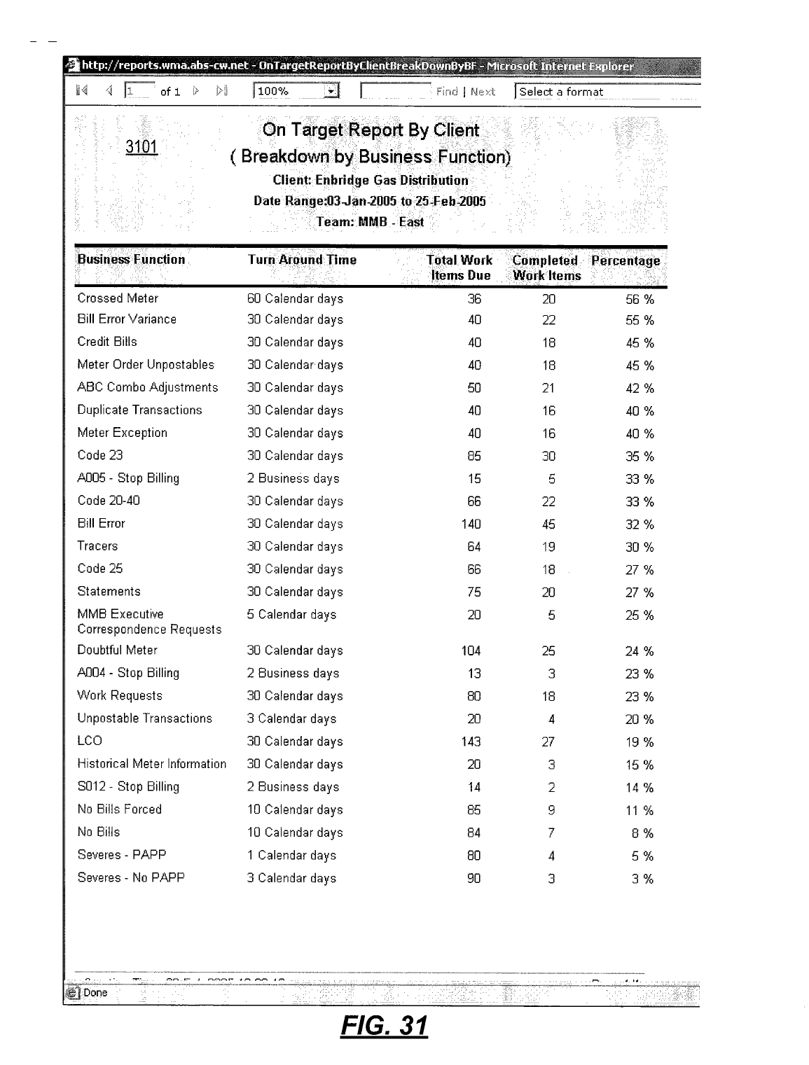

FIG. 30 illustrates the options screen 3001 when On Target Report By Client is selected from menu tree 505. In this example, the user inputs a desired team, date range, client (Enbridge Gas Distribution), and presentation, then selects the appropriate button to Generate Online Report. FIG. 31 illustrates the On Target Report By Client 3101 for the desired client.

While only specific examples have been illustrated in FIG. 5-FIG. 31, other reports and features provides similar options and views, as described above based on the functions, features and abilities provided by WMA 211.

One or more aspects of the invention may be embodied in computer-usable data and computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A data processing system, comprising:
a customer information system (CIS) generating a plurality of work items corresponding to a business entity responsible for operating said CIS;
a work item database;
a workflow management module communicatively connected to the CIS, receiving the plurality of work items from the CIS, and storing information corresponding to the plurality of work items in the work item database, said workflow management module automatically assigning each work item to an employee work queue selected from a plurality of employee work queues based on a skill set associated with each work item and a skill set associated with each employee work queue, and said workflow management module storing audit trail data corresponding to each work item in the work item database.

2. The data processing system of claim 1, wherein said stored audit trail data comprises a start time and an end time corresponding to when an employee corresponding to the assigned employee work queue for each work item indicated he or she began work on the assigned work item and resolved the assigned work item, respectively.

3. The data processing system of claim 1, further comprising a second customer information management system (second CIS) generating a second plurality of work items, wherein said second CIS is not natively compatible with the CIS, and wherein the workflow management module receives the second plurality of work items from the second CIS and stores information corresponding to the second plurality of work items in the work item database, said workflow management module automatically assigning each work item of the second plurality of work items to an employee work queue selected from the plurality of employee work queues based on a skill set associated with each work item of the second plurality of work items and the skill set associated with each employee work queue, and said workflow management module storing audit trail data corresponding to each work item of the second plurality of work items in the work item database.

4. The data processing system of claim 1, further comprising a scanner module that receives a scanned image of a paper document from an external scanner,
wherein the workflow management module automatically receives the scanned image from the scanner module and automatically creates a work item based on the scanned image.

5. The data processing system of claim 1, further comprising an electronic communication module that receives an electronic communication from a source external to the data processing system,
wherein the workflow management module automatically receives the electronic communication from the electronic communication module and automatically creates a work item based on the electronic communication.

6. The data processing system of claim 1, wherein each work item comprises an exception created by the CIS resulting from an error occurring during a business process function of the CIS.

7. The data processing system of claim 1, further comprising a reports module that analyzes user input defining a desired type of report and a desired scope of the report, queries the work item database based on the desired type and scope of the report, and outputs a report providing work item information based on the desired type and scope of the report.

8. The data processing system of claim 7, wherein the desired type of report is selected from types comprising productivity, volumes, utilization, and on-target.

9. The data processing system of claim 8, wherein the desired type of report is further selected from a set of sub-types comprising at least two of client, user, team, and business function.

10. The data processing system of claim 1, wherein said automatic assignment of each work item is further based on an availability of each employee work queue.

11. The data processing system of claim 10, further comprising:
an administration module exposing an ability for a user having predefined permissions to modify the availability of each employee work queue.

12. The data processing system of claim of claim 11, wherein the administration module further exposes the ability for the user having predefined permissions to modify a completion status of each work item.

13. The data processing system of claim 1, further comprising a web user interface module providing a user interface to each employee corresponding to one of the plurality of work queues upon successful login to the data processing system by the corresponding employee, said user interface comprising a list of one or more work items presently assigned to the employee work item queue corresponding to the logged in employee.

14. The data processing system of claim 13, wherein web user interface module color codes each work item in the list.

15. A method of managing an exception in an information system, comprising the steps of:
receiving a first exception from a first application of the information system, wherein the first exception corresponds to a request for manual resolution;
identifying a first end-user from a plurality of users to resolve the first exception;
assigning the first exception to the first end-user;
receiving a second exception from a second application of the information system, wherein the second exception corresponds to a request for manual resolution, and wherein the second application is different from the first application;
determining a second end-user from the plurality of users to resolve the second exception; and
assigning the second exception to the second end-user.

16. The method of claim 15, wherein the step of identifying a first end-user from a plurality of users to resolve the first exception includes the steps of:
determining at least one skill associated with resolving the first exception;
identifying at least one user having one or more skills corresponding to the at least one skill associated with resolving the first exception; and
selecting the first end-user from the identified at least one user.

17. The method of claim 15, wherein the step of identifying a first end-user from a plurality of users to resolve the second exception includes the steps of:
determining a work queue for each of the plurality of users; and
comparing the work queues of each of the plurality of users.

18. The method of claim 16, further comprising the steps of:
receiving a request from the first end-user to reassign the exception;
reassigning the exception to a third end-user, wherein the third end-user is selected from the at least one user having one or more skills corresponding to the at least one skill associated with resolving the first exception.

19. The method of claim 15, wherein the first end-user and the second end-user each have a work queue, wherein each work queue is prioritized.

20. The method of claim 15, wherein the step of identifying a first end-user from a plurality of users to resolve the first exception is based on a user input;

21. An information system for processing exceptions, comprising:
a plurality of service applications, wherein each of the plurality of service applications are configured to automatically a resolve a plurality of tasks and generate one or more exceptions corresponding to tasks that require manual resolution;
a data server for receiving the one or more exceptions from the plurality of service applications, wherein the data server configures data associated with each of the one or more exceptions to conform to a predefined format; and
a workflow manager configured to assign the one or more exceptions to one of a plurality of end-users based on a comparison of skills associated with the exception and skills of the plurality of end-users.

22. The information system of claim 21, wherein the data server includes a message-based application integration module.

23. The information system of claim 21, further comprising a security module configured to authenticate users of the system.

24. The information system of claim 21, wherein the workflow manager is further configured to generate statistics associated with a workflow of one or more end-users.

25. The information system of claim 21, wherein the workflow manager is further configured to prioritize a plurality of exceptions in a work queue of an end-user.

26. The information system of claim 21, wherein the workflow manager is further configured to determine an urgency level associated with one or more exceptions.

27. The information system of claim 21, wherein the workflow manager is further configured to track an audit trail for each exception.
